(19) United States
(12) Patent Application Publication
(10) Pub. No.: US 2009/0216629 A1
(43) Pub. Date: Aug. 27, 2009

(54) System and Method for Incentivizing a Healthcare Individual Through Music Distribution

(76) Inventors: Terry L. James, Fairview, TX (US); Grant K. James, Fairview, TX (US)

Correspondence Address: Patent Capital Group, 6119 McCommas Blvd, Dallas, TX, 75214, US

(21) Appl. No.: 12/035,168

(22) Filed: Feb. 21, 2008

(51) Int. Cl. G06Q 30/00

(52) U.S. Cl. 705/14

(57) ABSTRACT

A method for rewarding a healthcare individual at a remote location is presented in one example embodiment. The method includes interacting with a participant at a remote location and delivering a music segment in exchange for a successful completion by the participant of a health related activity. The music segment serves as a reward for the participant to complete the activity. The delivery of the music segment can be done via e-mail, a USB port exchange, or through a website. The interacting can be performed through a website, a health station, or a kiosk, for example. In other embodiments, the music segment is delivered to a device to be worn by the end user. The device could be a music player, an accelerator, a phone, a PDA, or a laptop. The music segment can be earned through a point system that relates to the activity performed by the participant.

### TECHNICAL FIELD OF THE INVENTION

This invention relates in general to health management and, more particularly, to a system and a method for incentivizing a healthcare individual through music distribution.

### BACKGROUND OF THE INVENTION

In the wake of rising healthcare costs, it seems as though virtually all companies have formed incentives that try to alleviate this problematic issue. Some companies may elect to use a point system, where users accumulate points that can be translated into some value proposition. Other companies use more blunt systems that involve giving away merchandise. In those systems, a user that performs well is given a prize (e.g., an extra vacation day, a gift certificate, etc.). Still other companies allow an end user to realize a reduction in their health plan premiums as a result of superior achievement in some endeavor.

A unique common thread in all these systems is the incentive. Incentive motivation is concerned with the way goals influence behavior. For example, a person might be willing to exercise regularly if offered the inducement of a potential reward when the task is completed successfully. On the other hand, that same person might not be willing to change if no motivational tool is ever provided.

Maintaining the current status quo is simply not acceptable, as our nation currently spends over $1.5 trillion on healthcare each year. The past twenty years has witnessed unrelenting cost increases in healthcare. Naturally, if the employee population is healthy and requires little or no medical services, the employer's cost will be minimal. If the employee population is not healthy, then the employer's cost could be unaffordable.

Surprisingly little attention has been given to the individual's role in the rising cost of healthcare. The common thinking of the day continues to be that sick or diseased patients, due to circumstances beyond their control, just randomly become ill. If patients are passive, are not playing an active role in the demand for medical services, and are only by-products of random misfortune, then any strategy that considers them is futile. If, on the other hand, the patient is a causal agent, then the chance to influence him must be fundamental in a risk management solution designed to affect healthcare expenditures.

Assume the individual is a fundamental causal agent in the risk for disease development and, further, a driving force for subsequent healthcare cost. If this holds, then individual choices are critical to determining the likelihood of the occurrence of disease and the severity of the disease process.

A natural product of this assumption is the notion of creating strategies that focus on the individual: the important component in this equation. Incentivizing this significant group of patients is a cornerstone of risk modification. Rewarding their compliance could potentially solve the seemingly insurmountable rising healthcare cost issues that plague this country today.

### SUMMARY OF THE INVENTION

From the foregoing, it may be appreciated that a need has arisen for an improved process for achieving superior modification of risk factors that drive disease by providing an optimal incentive system. In accordance with the present invention, disadvantages and problems associated with previous techniques for modifying risk factors may be improved upon [or eliminated] by offering a superior reward system.

In accordance with one embodiment of the present invention, a method for rewarding a healthcare individual at a remote location is presented. The method includes interacting with a participant at a remote location and delivering a music segment in exchange for a successful completion by the participant of a health related activity. The music segment serves as a reward for the participant to complete the activity.

The delivery of the music segment can be done via e-mail, a USB port exchange, or through a website. The interacting can be performed through a website, a health station, or a kiosk, for example. In other embodiments, the music segment is delivered to a device to be worn by the end user. The device could be a music player, an accelerator, a phone, a PDA, or a laptop. The music segment can be earned through a point system that relates to the activity performed by the participant.

In other embodiments of the present invention, a video segment is exchanged with the employee to further incentivize him. The video segment comprises access to digital content. The video segment could be a movie download, an episode of a TV series, an entire season of the TV series, a software package, a video game, etc.

Important technical advantages of certain embodiments of the present invention include providing a motivational tool based on current popular technology. Specifically, health data is monitored, collected, and processed in order to acknowledge compliance or a participant's participation with a health plan. The health plan may include any number of activities that foster a healthy lifestyle. The health station can store health data associated with the participant. Additionally, health station can collect biometric data and store this data associated with the participant.

In other scenarios, the end user has already logged certain information through their own personal computer, or their wearable devices can similarly be used as a conduit for collected health data. Furthermore, the health station can transmit a participant's health data to a healthcare individual. As a result, healthcare individuals can provide immediate and appropriate intervention plans for each participant based on health data associated with the participant. Healthcare individuals can also interact with participants to obtain any additional data needed. Furthermore, healthcare individuals can require participants to submit updated health data via health station periodically, such that a healthcare individual can monitor the progress of the participant. These interactions, as well as their music distribution counterpart, are described in greater detail below.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram that illustrates a system for providing an incentivizing tool through interaction with a health station connected to a network in accordance with a particular embodiment of the present invention;

FIG. 2 is a simplified flowchart that illustrates an example method for collecting data and providing an intervention plan through interaction with a health station connected to a network in accordance with an embodiment of the present invention;

FIG. 3A is a simplified block diagram that illustrates how an end user device can be used with a computer in accordance with a particular embodiment of the present invention;

FIG. 3B is a simplified block diagram that illustrates several communication systems in accordance with a particular embodiment of the present invention;

FIG. 3C is a simplified block diagram that illustrates an end user device in accordance with a particular embodiment of the present invention;

FIG. 3D is an example of the display of a user's daily points in accordance with an embodiment of the present invention;

FIG. 3E is an example of the display of a user's goal for total weekly calories in accordance with an embodiment of the present invention;

FIG. 3F is an example of the display of a user's goal for pills consumed in an auxiliary mode in accordance with an embodiment of the present invention;

FIG. 3G is a simplified flowchart that illustrates an example method of the communication system in accordance with an embodiment of the present invention;

FIG. 3H is a simplified flowchart that illustrates another example method of the communication system in accordance with an embodiment of the present invention;

FIG. 4 is a simplified block diagram of a data processing system for delivering and administering certain features of the present invention;

FIG. 5 is a simplified flowchart that illustrates an example of an algorithm in a health station in accordance with an embodiment of the present invention;

FIG. 6 is a simplified flowchart that illustrates an example method for providing an intervention plan for an acute illness in accordance with an embodiment of the present invention;

FIG. 7 is a simplified flowchart that illustrates an example method for providing an intervention plan for weight management in accordance with an embodiment of the present invention;

FIG. 8 is a simplified flowchart that illustrates an example method for providing an intervention plan for heart disease in accordance with an embodiment of the present invention;

FIG. 9 is a simplified schematic diagram of a number of example modules that may be completed as part of the process and the method for managing healthcare expenditures; and

FIG. 10 is a simplified schematic diagram illustrating the interaction between the patient's completion of assigned modules and the ability to be rewarded with a music distribution in various formats.

### DETAILED DESCRIPTION OF THE INVENTION

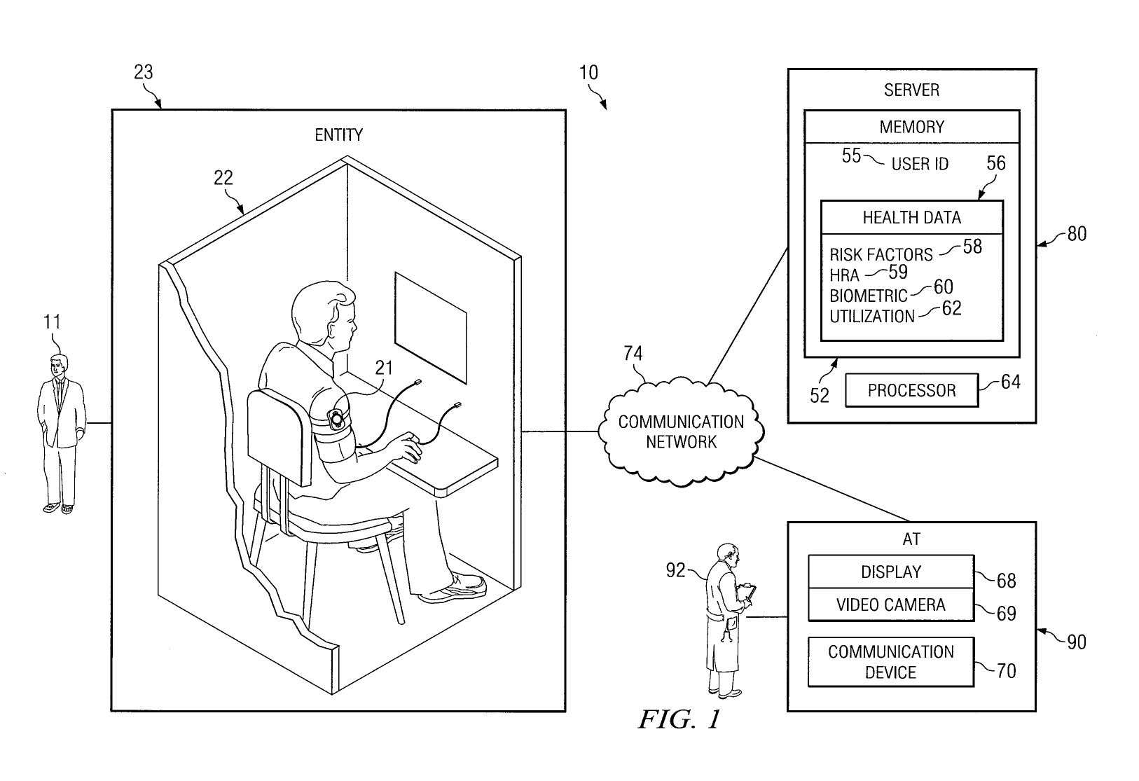

FIG. 1 is a simplified block diagram of a system 10 for providing an incentivizing plan through music distribution. In one example, this is achieved via a health station 22, which is connected to a network. In another example, a simple website could be used as the platform for delivering the music reward to a given end user.

According to the embodiment of FIG. 1, system 10 includes a participant 11, health station 22, a corporate entity 23, a communication network 74, a server 80, an access terminal 90, and a healthcare individual 92 (e.g., a physician who could optionally monitor any data received through health station 22). Server 80 could provide a website that is operable to interface with participant 11 at any given time. Alternatively, server 80 could easily offer a gateway to the aforementioned website. The website could be a corporate website, with a portal for a participant to log his health data, or it could be a third-party website that stores this health data (as a courtesy or for a fee) for the corporate entity. In a similar fashion, the website itself could be relegated responsibility for delivering the music reward (e.g., through e-mail, through conventional mail via a CD, through a USB cable to an end user's device, etc.). In that scenario, the third party could provide a custodial service for the parent company and keep track of copyright obligations, as further detailed below.

Health station 22 may also include a memory 52, participant identification 55, health data 56, risk factors 58, health risk appraisal data 59, biometric data 60, utilization data 62, a processor 64, an interface, a display 68, a video camera 69, one or more communication devices 70, a port 71, and one or more biometric collection devices 72. Server 80 includes memory 52, participant identification 55, health data 56, risk factors 58, health risk appraisal data 59, biometric data 60, utilization data 62, and a processor 64. Access terminal 90 includes a display 68, a video camera 69, and one or more communication devices 70. Note that many of these items could be removed from the current health station arrangements, as the example of FIG. 1 is providing a comprehensive solution that offers a myriad of potential choices. For example, some of the items could be simply removed to offer a streamlined version of the present solution.

In accordance with the teachings of one configuration of the present invention (specifically, a health station model), communication system 10 achieves an effective way for participants 11 to be rewarded for a successful completion of their assigned tasks. This delivery can be performed at a remote health station 22.

Taking a step back from the exact nuances of the present invention, note that virtually all companies have incentives (point systems, merchandising systems, etc.) to address rising healthcare costs. One distinction to be drawn between those systems and the proposed architecture is that the present invention can be used on either a short-term or a long-term basis. The parent company or business (that employs the participant) is empowered to set timeframes for the participant: those time frames being due in the near-term or over an extended period. In turn, the participant is rewarded immediately or systematically over a longer period of time.

For example, a participant may be assigned a near-term goal of performing a certain activity three times per week, while his long-term goal may be to lose 40 lbs. Progressively, health station 22 can monitor his achievements in both endeavors. Furthermore, as an incentive, health station 22 can deliver music to participant 11 as an enticement for continued and future compliance. The song can be delivered in any suitable manner (e.g., it can be downloaded, or transferred to a library, a hard drive, a device such as an MP3 player, etc.). Intuitively, the end user begins to understand that he will be rewarded quickly for his accomplishments.

Additionally, Kinetic Activity Monitor (KAM) points (which are further detailed below) can be earned by the participant. These points (or other types of merit points) can be used as currency such that an end user could earn points during the week and then convert those points to a song, an entire album, etc. depending on the conversion factor being used by the employer. The reward system could be used in any type of environment (e.g., a school system, a corporate/employment environment, etc.).

The architecture of the music program can utilize a Digital Rights Management (DRM) protocol in one example. This would be employed at the website and/or used by the health station in doling out these music segments. Typically, DRM protocols allow the purchaser to have 4-7 DRMs of that music segment (this is typically dependent on the originating label). At least one copy of the music segment could be maintained at the home community website such that the end user who was originally entitled to that music segment can access it. Logically, this would allow a website operator to be able to effectively manage copyright issues, as well as troubleshoot any glitches or problems in accessing or downloading the music segment. In one example scenario, a second copy can be put on the actual device that the end user is currently using. This could be an accelerometer/music device as outlined herein, or a simple MP3 player, a computer's hard-drive, etc. Any suitable device could used in conjunction with the health station to accommodate this music distribution to which the participant is entitled as a result of his performance.

Note that in contrast to other systems, the original DSM serial number can be maintained by the home website such that the end user can verify how many copies are remaining to be used or licensed. The actual music management system could be used in conjunction with any selected wellness program: some of which are provided below for purposes of example. In essence, a kiosk, a web site, the aforementioned health station 22, or a personal computer could be leveraged in order to provide a platform for exchanging KAM points (or data indicative of specific performance) for a discrete music segment.

In contrast to the architecture of the present invention, no current healthcare paradigm is using music as part of an incentive/reward system in a health context. In essence, new emerging technology is being incorporated into a health system in the present invention. The architecture behind the concept allows for an almost immediate transfer of music to the end user.

In practical terms, this means a given end user could leave a company's web-site, kiosk, health station, or his personal computer with a tangible item of music placed either on their computer (e.g., now on the hard drive) or a device (e.g., a memory stick for an MP3 player) or a CD. The user could be given an option of receiving his music reward through his e-mail, through a CD burned for him, or through his preferred device.

Video data can also be exchanged under the outlined protocol. For example, after successful completion of some assigned task, or after performing some job, or achieving some result, a given employee could be rewarded with a movie download, an episode of a TV series, an entire season of the TV series, a video game, a software package (e.g., a user receives TurboTax after successful completion of some activity, or the Windows Operating Platform (e.g., Vista)), etc. This incentivizing system would include access to such items over a network connection such that an employee could watch any type of video on his PDA [e.g., Palm Pilot, Blackberry, Treo, etc.], desktop computer, laptop computer, etc. Any digital content can be used in order to suitably entice the employee into performing some activity.

Note that aside from this music/video delivery paradigm, a physician can deliver a diagnosis or intervene (where appropriate) when participants 11 visit the health station. This is an ancillary benefit to being able to see this crucial participant data, as the participant periodically checks in. Participants 11 can visit health stations 22 to receive health management from healthcare individuals 92 such that participants 11 can immediately receive care related to an acute illness, chronic illness, or modification of risk factors for disease through an intervention plan. Participants 11 can interact with healthcare individuals via health station 22, which is connected to communication network 74.

For example, participants 11 and healthcare individuals 92 can interact via a live video feed between health station 22 and access terminal 90. Health station 22 can store a multitude of health data 56 associated with participant. Additionally, health station 22 is operable to measure and store biometric data 60 of participant 11. Healthcare individuals 92 can receive this health data 56 associated with each participant 11 immediately. Healthcare individuals 92 can also obtain additional health data 56 by interacting with participant 11 via live video on health station 22. Healthcare individuals 92 can provide appropriate intervention plans to participants 11 based on the health data 56 and any additional data obtained from participants 11. Intervention plans can be related to any concern by participant 11, including acute illness, chronic illness, and risk modification for disease. Software and/or hardware may reside in health station 22, the home community website, and/or access terminal 90 and/or server 80 in order to achieve the teachings of the features of the present invention. A given end user device can also include such software such that the music distribution is made easier or faster for the participant. The software can execute code to perform the operations as outlined herein.

Note that, due to their flexibility, these components may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of health station 22 and/or access terminal 90 and/or server 80 and/or device 21 in the context of system 10 and, accordingly, they should be construed as such.

It should be noted that the internal structure of the system of FIG. 1 is versatile and can be readily changed, modified, rearranged, or reconfigured in order to achieve its intended operations or additional operations. Additionally, any of the items within FIGS. 1-10 may be combined, where appropriate, or replaced with other functional elements that are operable to achieve any of the operations described herein.

While system 10 is aimed at music distribution, the architecture lends itself to important benefits in a healthcare environment. For example, because the data input by participant 11 can be accessed by a healthcare professional, this data can serve as a trigger for interventions, or plans that address issues confronting participant 11. This could involve assigned modules, as further detailed below.

The present invention does utilize some technology previously applied for by Applicant. Note that the following related cases, which address aspects of the aforementioned website, healthcare methodologies, and features of end user devices, are hereby incorporated by reference: Accelerometer for Data Collection and Communication, Ser. No. 10/996,500, filed Nov. 23, 2004; System and Method for Implementing an Interactive Online Community Utilizing an Activity Monitor, Ser. No. 11/625,063, filed Jan. 19, 2007; System and Method for Population Health Management Data Collection and Communication: Ser. No. 10/915,852, filed Aug. 11, 2004; System and Method for Modifying Risk Factors By a Healthcare Individual at a Remote Location: Ser. No. 11/760,457, filed Jun. 8, 2007; and Music and Accelerometer Combination Device for Collecting, Converting, Displaying, and Communicating Data: Ser. No. 11/866,520, filed Oct. 3, 2007.

Because the terminology associated with some of the elements of system 10 is malleable, it is helpful to offer some initial descriptions that address their meanings. As used herein, an intervention plan may be defined as an introduction of a variable (behavioral, chemical, process, etc.) that is designed to affect a risk factor that is present or could develop in a target participant or population. Therefore, an intervention may include a change, addition, or modification to any relevant risk factor associated with participant. In the context of an intervention, a number of modules may be introduced to affect behaviors of the targeted individual or group. The term ‘module’ is a task to be completed by the targeted participant. A module is defined in more detail below.

Within the structure of a given intervention plan, examples of a module from health station or healthcare individual may include having the participant change a prescription from medicine A to medicine B or a change in treatment from Dr. A to Dr. B (or a treatment protocol being changed while remaining under the care of the same physician). An example of an activity shift could include a recommendation to increase a level of physical fitness, to refrain from certain activities that pose an increased health risk, or to take precautions based on a particular set of symptoms or conditions identified for that particular participant. Other behavioral changes may stem from data that suggest certain categorical groups (e.g. age, gender, race, etc.) or populations may be more susceptible to designated afflictions (e.g., a healthcare individual could recommend annual mammograms for women over the age of 35). In still other scenarios, the intervention could involve a process to be implemented, whereby participant may be asked to interact with a nurse every twelve hours, immediately report cold symptoms to a primary physician, or log daily testing information in an electronic journal. All of these modifications may be part of one or more designated modules for the target participant or population of participants. Such modules are discussed more fully below.

Once health data associated with participant has been obtained, a specific intervention plan may be introduced that is designed to modify the participant's risk factor and achieve productive results. For example, if high blood pressure or high blood sugar is discovered to be a risk factor in a participant, an intervention would be applied (e.g. weight management) for that participant to reduce the negative health effects associated with obesity.

As used herein, the term “module” includes any task to be completed by the targeted participant in the context of an intervention plan. Completion of the modules can earn merit points of some kind (e.g., KAM points) that can be used or swapped for music segments. Thus, music distribution is serving as motivation for module completion, or adherence to a given healthcare plan for participant 11.

The modules can be selected intelligently from health station or server based on participant's health data, such that modules are displayed to participant via health station. Alternatively, modules can be created by healthcare individuals based on participant's health data, such that healthcare individual explains module via live video feed to participant at health station. In the context of an intervention plan, the modules are designed after analyzing the health data and identifying relevant risk factors associated with the target population. Hence, the identified relevant risk factors can be used as the basis for configuring the modules, which can be interactive and which specifically address the (potentially modifiable) targeted clinical risk factors, character observations, or disease states of the target population. Considerable time and effort may be expended in designing the precise modules that will yield the most beneficial results for the target group and, thereby, alleviate the healthcare costs for a given population of participants.

Alternatively, a healthcare individual can immediately develop a module customized to participant based on participant's health data transmitted from health station. Thus, the modules in the context of an intervention plan are designed to modify risk factors and related healthcare expenses for a given participant or group, as determined by the identification of relevant risk factors and health data associated with participant. The modules associated with an intervention plan may also achieve a reduction in healthcare expenses by modifying the choices of the participant so that the participant chooses new behaviors or abandons old behaviors that are costly (e.g. calling the nurse line instead of going to the emergency room as a first choice in seeking health management).

Therefore, a module associated with an intervention plan could include virtually any action, exercise, or assignment that may affect a participant's beliefs, feelings, thoughts, or behaviors. This is inclusive of a participant refraining from doing some action or intentionally not participating in certain endeavors. There could be a series of successive modules to be completed by a participant in a particular order, or the modules could be completed in a random fashion. A module associated with an intervention plan is tailored specifically for a participant or a group of participants and, therefore, modules are considerably flexible and malleable. A module associated with an intervention plan may be completed during normal business hours (potentially under the supervision of an administrator), during non-business hours where the ‘honor system’ is employed, or anytime. Furthermore, an incentive program can be implemented, such that more participants will comply with intervention plans.

Note that the modules associated with the intervention plans are primarily action or process-oriented, as opposed to information-oriented, so that their focus is on the facilitation of change in participant. The modules are designed to allow participant to acquire skills and life applications of the learned information. Participant may be asked to respond affirmatively in order to address certain subject matter. In addition, participant may be required to perform specific tasks. Rewards may then be given based on the performance of the modules by participant, as he completes, applies, acquires, or participates in proscribed assignments within the modules.

A module associated with an intervention plan could include educational tools, such as a booklet, video, or computer program designed to address the illness, behavior, or issue presented by the target participant or group. For example, if the issue were stress management, a video could include information about proper diet (e.g. inclusive of caffeine restrictions), breathing exercises, time management, and sleeping suggestions. The booklet could include electronic fill-in the blank questions that quiz participant on the lessons learned.

Modules associated with an intervention plan can also be related to physical exercises to be completed by participants. An honor system may be employed for such a module or participant may wear some type of activity monitor (e.g. a pedometer for tracking walking, a heart rate monitor for tracking other activities, etc.). In addition, a module associated with an intervention plan may include work completed using access terminal, health station, and, potentially, monitored by an on-line administrator. A module associated with an intervention plan could also simply be the completion or achievement of a specific goal. In the case of a person with heart disease, a reduction of participant's weight by fifteen pounds may signify performance or completion of the module. Participant can utilize weight scale on health station to record weight and transmit weight electronically to healthcare individual, such that healthcare individual can check if participant is complying with module. Other modules associated with an intervention plan could include the verification of medication usage in the presence of a healthcare individual.

According to the illustrated embodiment, system 10 provides services such as communication sessions to endpoints, such as access terminal 90 and health station 22. A communication session refers to an active communication between endpoints. Information may be communicated during a communication session. Information may include voice, data, text, audio, video, multimedia, control, signaling, and/or other information. Information may be communicated in packets, each comprising a bundle of data organized in a specific way for transmission.

System 10 may utilize communication protocols and technologies to provide communication sessions. Examples of communication protocols and technologies include those set by the Institute of Electrical and Electronics Engineers, Inc. (IEEE) standards, the International Telecommunications Union (ITU-T) standards, the European Telecommunications Standards Institute (ETSI) standards, the Internet Engineering Task Force (IETF) standards (for example, IP such as mobile IP), or other standards.

According to the illustrated embodiment, participant 11 represents any individual who is being incentivized through a music distribution. Participant 11 can visit health station 22 and immediately receive appropriate care from a healthcare individual 92. Participant 11 may also participate in risk modification via health station 22. Risk modification and intervention plans can include plans designed to affect participant's health conditions, such as diabetes, weight management, heart disease, etc. Additionally, participant 11 can visit health station 22 to measure biometric data 60. Participant 11 can also dock activity monitor with health station 22, such that participant can upload and view activity data. In another embodiment, participant 11 may be an employee who is required by employee's employer to visit health stations 22. In another embodiment, participant 11 may be an individual in a nursing home who is required to visit health station 22 on a periodic basis. In another embodiment, participant 11 may be a student who is required to dock activity monitor as part of a physical education curriculum.

According to illustrated embodiment, health station 22 represents any suitable device operable to collect biometric data 60 from participant 11, provide visual and audio communication session between participant 11 and healthcare individual 92, and exchange information between participant 11 and healthcare individual 92 in essentially real-time. Health station 22 may represent a computer, server, or data processing system, depending on context and applicable tasks. In the current embodiment, health station 22 is located within an entity 23. Health station 22 can include a memory 52 storing a participant's identification data 55 and health data 56 (for example, risk factors 58, health risk appraisal data 59, biometric data 60, and utilization data 62), processor 64, a network interface, display 68, video camera 69, one or more communication devices 70, port 71, and one or more biometric collection devices 72. Health station 22 can be constructed from any material with any suitable design.

For example, health station 22 may be constructed from wood in the shape of a bench seat, including a monitor, a telephone, a video camera, and a weight scale, such that the weight scale is positioned under the seat so that participant can measure weight while sitting. In another embodiment, health station 22 may be constructed from metal in the shape of a rectangular box, including a monitor, built in speaker, and built in microphone. Participants 11 can interact with health station 22 to receive an intervention plan from a healthcare individual 92 via a video session. Health station can schedule an appointment for individual to connect to healthcare individual via a live video session. Alternatively, health station can show a pre-recorded video session to communicate between participant and healthcare individual.

Health station 22 can capture a multitude of data. For example, health station 22 can capture participant's name, risk factors, health risk appraisal data, biometric data, utilization data, medical records, health insurance enrollment data, and any other relevant data. Health station 22 can save data associated with each participant on a remote server 80, such that health station 22 will have participant's information on subsequent visits. Health station 22, including biometric collection devices and electronic intervention modules, can be customized and configurable by authorized individuals, such as healthcare individuals 92. For example, entity ABC can configure their health station 22 so that activity monitors can connect to health station. Other architectures and components of health station 22 may be used without departing from the scope of this disclosure.

In an alternative embodiment, participant 11 can communicate with a healthcare individual to receive acute care or participate in an intervention plan by using a computing device with a display, such as a desktop computer, laptop, PDA, cell phone, etc. For example, healthcare coverage from employer may also cover spouses of employees. A spouse of employee can use their computer at home to communicate with a healthcare individual over a real time, live video connection.

Entity 23 can be any business, school, commerce, or public location where health station 22 or computing device is located. Entity 23 can include a company, a university, a residence, an elementary school, a nursing home, a grocery store, a gym, etc. For example, a company can use health station 22 to lower costs and increase productivity from employees. Employees at company can visit health station 22 rather than a doctor's office when employee is feeling sick, which can provide employee with an immediate health management and minimize the time employee is away from work.

Employees at company can also visit health station 22 to participate in risk modification interventions for general health risk, such as weight management and risk factors specific for heart disease, such as lowering a participant's LDL. Note that health station 22 can be bypassed entirely for participant 11 visiting a website that is linked to the individual. For example, the website can log the participant's data and maintain a healthcare profile for the end user.

Memory 52 may be located in health station 22, server 80, the web site, and/or access terminal 90. Memory 52 accessed or otherwise utilized by one or more components of health station 22, server 80, or access terminal 90. Memory 52 may take the form of volatile or non-volatile memory including, without limitation, magnetic media, optical media, random access memory (RAM), read-only memory (ROM), removable media, or any other suitable local or remote memory component. In general, memory 52 may store various data including participant's identification data, health data, and modules.

Participant identification 55 can be stored on health station 22 and/or server 80. Participant identification 55 is used by health station 22 and server 80 to store and update health data 56 associated with participant 11. Participant identification 55 can be obtained from a card reader, fingerprint scanner, or any other well-known software or hardware authentication system. In one particular embodiment, health station 22 and server 80 can recognize participant's identification 55 from participant's activity monitor connected to health station 22. Alternatively, health station 22 can prompt participant 11 for participant identification and password. Each participant 11 can receive a personalized experience with customized settings stored in memory associated with participant's identification 55.

Health data 56 can be any data associated with participant 11. Health data 56 is analyzed by healthcare individuals 92 to provide an appropriate intervention plan customized to each participant 11. Health data 56 can include risk factors 58, health risk appraisal data 59, biometric data 60, utilization data 62, intervention plans, and any other data related to participant's health.

Risk factor 58 is a clinical observation that has been statistically demonstrated to participate in the development of a given disease. Healthcare individuals 92 can determine risk factor 58 of participant 11 by analyzing health data 56 or asking participant 11 questions during live video session. For example, if participant 11 is sedentary, obese, or is a smoker, participant 11 has clinical risk factors 58 for heart disease. However, there are other clinical observations that would not qualify as a “clinical risk factor.” For example, the fact that participant 11 was a certain height or had poor vision would not necessarily qualify as a clinical risk factor 58 for heart disease.

Clinical risk factors 58 tell you if participant 11 is at risk for developing a disease or condition, but clinical risk factors 58 do not tell you when that disease process is likely to occur, the appropriate intervention plan to modify risk factors, or its potential cost for the party bearing the economic risk.

By merging clinical risk factors 58 with other data domains, healthcare individuals 92 can determine a proper health management to provide both acute care and acute surveillance for a given participant. For example, a healthcare individual 92 can determine that participant 11 who has risk factors 58 related to smoking may receive different health management than participant 11 who has no risk factors 58 for smoking. Healthcare individual 92 can provide acute surveillance by requesting that a smoker with a respiratory infection call back every twelve hours so that healthcare individual 92 can track participant's illness. Alternatively, healthcare individual 92 may not need to provide acute surveillance for a non-smoker with a respiratory infection since this participant 11 does not pose as high a risk.

As used herein, health risk appraisal data 59 represents information that is extracted indirectly or directly from participant 11 or healthcare individual 92. This information may be self-reported, for example, through a questionnaire or an interview that is completed by participant 11. Examples of such information include data relating to family history, current symptoms, previous surgeries, nutrition, smoking and alcohol habits, occupation, gene sequence, medication (past or present), or allergies. Note that because such information may reflect a specific trait of a participant 11 or a population of participants 11, their specific constraints or conditions may be accounted for and accommodated.

For example, the fact that participant 11 is an investment banker in Manhattan, N.Y. may reflect a high stress level. Health risk appraisal data 59 could reveal such information, whereby the interview and/or the questionnaire could directly solicit this important fact. Thus, the interview and/or the questionnaire may be customized to address a particular population or particular participant. Consider another example where participant population is predominantly women. Appropriate questions for the interview and/or the questionnaire may then be associated with family history and breast cancer (note that gene sequence identification may be part of such an inquisition, as certain identified gene sequences do reveal a greater likelihood of breast cancer) or capabilities related to procreation potential. Numerous other examples of health risk appraisal data 59 are provided herein in this document for purposes of example and illustration. Alternatively, health risk appraisal data 59 could include any other suitable self-reported information, condition, symptom, or any other relevant fact, parameter, or piece of data that is relevant to the health of the individual or the group being evaluated.

As used herein, biometric data 60 reflects measured health information that is not necessarily self-reported. This information may be gathered from (or relate to) participant 11 and generally reflects physical data, which is measured. In this particular embodiment, health station 22 is operable to measure participant's biometric data 60, including blood pressure, pulse, glucose levels, weight, air flow, etcetera. Health station 22 can collect detailed measurements of biometric data 60. For example, health station 22 can collect detailed measurements related to heart pressure, such as systolic pressure, diastolic pressure, and heart rate. Biometric data 60 may relate to diagnostic information that could be provided in a laboratory report or gathered, for example, during the course of a magnetic resonance imaging (MRI) scan, in the context of evaluating an employee, or in performing some type of lab work or blood-work. In other scenarios, biometric data 60 may involve assessing body fat and blood cholesterol, lung capacity (e.g. using a flow meter), height, density and weight measurements, or any other suitable test or evaluation that yields some tangible result for an examining healthcare individual. In still other embodiments, this could include testing (e.g. psychiatric evaluations) that involves questionnaires, inkblot tests, etc. Alternatively, biometric data 60 could include any other suitable physical measurement, dimension, relevant health fact, parameter, or piece of data that may be collected by a physician, nurse, or representative authorized to do so.

As used herein, utilization data 62 refers to economic data that reflects financial information tied to the person or group being evaluated. This could include how much money is spent on pharmaceutical supplies, or some particular event such as a doctor visit or a trip to an emergency room at a local hospital. Utilization data 62 may be solicited from a third party carrier or a third party administrator or, alternatively, through any other suitable entity. This may be inclusive of records searching in an appropriate database or file system. Utilization data 62 may reflect an economic event in which medical service triggered any type of fee. Such data is tied into costs incurred by a participant or by an employer on behalf of the participant. Alternatively, utilization data 62 could include any other suitable information or piece of data that may affect expenses or healthcare costs for participant or group of participants that is being evaluated.

Processor 64 can be located in health station 22, server 80, and access terminal 90. Processor 64 controls each device by processing information and signals. Processor 64 includes any suitable hardware, software, or both that operate to control and process signals. Processor may be microprocessors, controllers, or any other suitable computing devices, resources, or combination of hardware, software and/or encoded logic. In one particular embodiment, processor is operable to intelligently select intervention modules based on participant's health data. In a particular embodiment, processor 64 in health station 22 is operable to receive software, module, and website updates from centralized server 80. For example, health station 22 can receive new software from server 80 for measuring biometric data from a new biometric collection device, such that an individual does not have to make software changes to each health station 22 at a remote location.

Display 68 on health station 22 and access terminal 90 is operable to display one or more images in one or more formats. Images viewed on display 68 may include websites, streaming video, digital photographs, or any other suitable image. For example, participant 11 can view website associated with participant's health data and an embedded window within website that streams live video of healthcare individual 92. In another embodiment, display 68 can be a touch screen, such that participant 11 will have a more interactive experience. Since display 68 is touch screen, participant 11 can interact with health station 22 without a mouse or keyboard.

Video camera 69 on health station 22 and access terminal 90 is operable to stream live video of participant 11 or healthcare individual 92 across network 74. Additionally, video camera 69 is operable to take digital photographs and transmit digital photograph across network 74. For example, on initial visit to health station 22, participant 11 may take photograph from video camera 60 for participant's personalized webpage. Participant 11 can then connect to a live video feed with healthcare individual 92, such that participant 11 and healthcare individual 92 can see and speak with one another in essentially real time to provide a personal one on one experience.

Communication devices 70 on health station 22 and access terminal 90 are operable to facilitate communication. For example, communication devices 70 can include a microphone, speaker, keyboard, mouse, etc. Communication devices 90 may be internal to health station 22 or access terminal 90 or communication devices 90 may be an auxiliary device attached to health station 22 or access terminal 90.

Port 71 on health station 22 is operable for any electronic device to communicate with health station 22 and network 74. In one particular embodiment, participant 11 can log into health station by connecting activity monitor to port 71. Health station 22 can then automatically upload participant's website and participant's personal data. In another embodiment, participant 11 may upload digital photographs from a digital camera to memory in health station 22 or server 80, such that participant 11 connects digital camera to port 71.

Biometric collection devices 72 on health station 22 are operable to measure and store participant's biometric data 60 in memory 52. Biometric collection devices 72 can measure blood pressure, pulse, glucose levels, weight, airflow, etc. Biometric collection devices 72 are also operable to store data in memory 52 and transmit collected biometric data to health station 22, server 80, and/or access terminal 90. In one particular embodiment, participant 11 can place arm in cuff attached to health station 22, such that cuff measures participant's blood pressure. Blood pressure cuff can collect detailed measurements related to blood pressure, such as participant's systolic pressure, diastolic pressure, and heart rate. In another embodiment, participant 11 can sit down and place feet on bar positioned under the seat of health station 22, such that bar accurately measures participant's weight. In another embodiment, participant 11 may step on a traditional weight scale attached to health station 22, such that scale accurately measures participant's weight. Biometric collection devices 72 allow for healthcare individuals 92 to receive biometric data 60 and provide an immediate intervention plan to participant 11 located at remote health station 22.

System 10 includes a communication network 74. In general, communication network 74 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding.

Servers 80 are generally operable to provide an interface between participant health data 56 and healthcare individual. Servers 80 can include a website that offers any of the features outlined herein (e.g., maintaining participant data, interfacing with the participant generally, providing a link between the parent entity/business and the participant, offering a third-party outsourcing such that the third party is responsible for controlling music delivery, copyright data obligations, delivering the music to participant 11, etc.).

Servers 80 are also generally operable to store intervention plans, health data 56, and customized settings associated with participant 11 interacting with health station 22. One or more servers 80 may be web application servers or simple processors operable to allow healthcare individuals 92 to view and process participant health data 56 and intervention plans via the communication network 74 using a standard participant interface language such as, for example, the Hypertext Markup Language (HTML). In some embodiments, one or more servers may be physically distributed such that each server 80, or multiple instances of each server, may be located in a different physical location geographically remote from each other. In other embodiments, one or more servers 80 may be combined and/or integral to each other. One or more servers 80 may be implemented using a general-purpose personal computer (PC), a Macintosh, a workstation, a UNIX-based computer, a server computer, or any other suitable processing device.

Servers 80 are also operable to transmit updated software, music segments (i.e., discrete music files), modules, and websites to health stations 22, such that authorized individuals only have to make one update without visiting every health station 22. For example, authorized individual can create new software for recording biometric data 60 from a newly installed biometric collection device 72. Server 80 can transmit this new software to each health station 22, such that health station 22 will automatically receive the software update.

In another embodiment, server 80 is operable to intelligently select intervention modules customized to participant 11 based on participant's health data. The intelligently selected intervention modules can be transmitted to participant 11 or healthcare individual 92. Healthcare individual 92 (which, as used herein, can be interchangeable with ‘end user’ or ‘participant 11’ in certain instances) can use the intelligently selected modules to help guide selection of a customized intervention plan for participant 11. For example, a nineteen-year-old overweight male with high blood pressure may receive modules on sexually transmitted diseases (health concern of young males) and weight management. A forty-five year old woman with normal weight and blood pressure may receive modules on cervical cancer and breast cancer.

In some embodiments, servers 80 are operable to provide security and/or authentication of participants 11 connected to health station 22 or healthcare individuals 92 attempting to access participant's health data 56.

In particular embodiments, one or more servers 80 are web application servers operable to communicate dynamically updated information to particular access terminal 90 and/or health station 22 via communication network 74. For example, one or more servers 80 may communicate dynamically updated information of biometric data to particular access terminals 90 via communication network 74.

According to the illustrated embodiment, access terminal 90 represents any suitable device operable to transmit a video stream and communicate with a communication network 74. Access terminal 90 can include a display 68, video camera 69, and one or more communication devices 70. For example, healthcare individual 92 may use access terminal 90 to receive a video stream and audio stream of participant 11 at remote health station 22. Access terminal 90 can also receive health data, modules, or images associated with participant 11 from health station 22 and/or server 80. Access terminal 90 may comprise, for example, a personal digital assistant, a computer such as a laptop, a cellular telephone, and/or any other device operable to communicate with system 10. Access terminal 90 may be a mobile or fixed device.

Healthcare individual 92 can be any qualified individual (licensed or non-licensed individual) capable of providing health management and risk management to participant. Health management may include acute care, evaluation, triage, treatment, and information. Risk management may include assessing risks, designing an intervention plan, determining risk modification, implementing the intervention plan, and evaluating effectiveness of the intervention plan. Risk modification can include preventing risks, reducing present risks, and attenuating risks associated with a health condition, such as heart disease and diabetes. Healthcare individuals 92 can include physicians, nurses, dieticians, exercise trainers, health coaches, or any individual authorized to make intervention plan decisions based on participant health data 56. Healthcare individual 92 can be contacted via a live video stream from participant 11 at remote health station 22. Healthcare individual 92 can apply acute care for acute illnesses. Healthcare individuals 92 can provide different intervention plans for different participants 11 based on participant's health data 56 and symptoms. By receiving intervention plans or care from a real person on a live video stream, participants will have a more personalized one on one experience. In addition, a qualified healthcare professional providing intervention plans will provide more credibility to intervention plans, which will increase participation in intervention plans. Furthermore, healthcare individuals 92 can apply intervention plans in a preventative way to a single participant 11 or a group of participants 11 at entity 23 based on health data 56 stored on server 80. For example, healthcare individual 92 may enroll all heart attack victims in a heart smart plan, which is designed to lower the risk factors associated with a future cardiac event. Participants 11 will be more likely to participate in intervention plans when they are required to explain progress to healthcare individual 92 face to face over a live video stream. Additional details of healthcare individuals 92 applying intervention plans based on participant's health data 56 transmitted from health station 22 and/or server 80 are listed below.

In another embodiment, healthcare individual 92 can work for an insurance carrier. Insurance carrier can use health stations 22 to maximize profitability. Insurance carriers can charge premiums to entities 23 or participants 11 for short term and long-term disability. The amount the insurance carrier charges entities 23 or participants 11 for the premiums are based upon risk. Insurance carriers can use health stations 22 to receive immediate intelligence and health data 56 on participant population of entity 23 to limit the costs associated with participant's healthcare. For example, healthcare individual 92 can determine an appropriate intervention plan for participant 11 based on participant's health data 56. This intervention plan can prevent an illness from becoming a short-term disability, and prevent a short-term disability from becoming a long-term disability. Additionally, if a high risk participant gets ill, then carriers can budget for a high-risk patient that may go on long-term disability. Therefore, health station 22 can provide health data 56 that has value at the insurer level and at the caretaker level.

In another embodiment, healthcare individual 92 can use health station 22 to sort and process participant health data 56 to provide intervention plans to population of participants at a particular entity 23. Participation in the group intervention plans will result in lower healthcare costs and fewer employee absences. Additional details of healthcare individuals 92 providing preventative intervention plans based on participant's health data 56 are listed below.

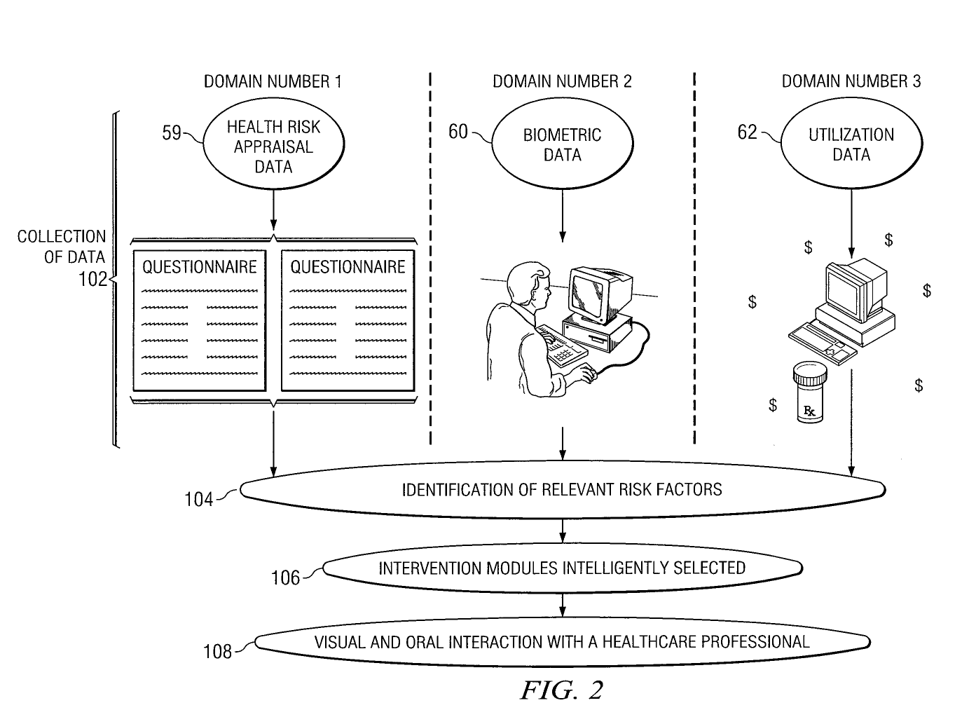

FIG. 2 illustrates an example method for collecting health data 56 from multiple domains and providing intervention plans based on this health data 56 in accordance with one embodiment of the present invention. At step 102, health station, entity and/or healthcare individuals collect data from participant. System may include three domains of information, which are used as a basis for identifying relevant economic risk factors and for providing customized intervention plans. The domains include: health risk appraisal data, biometric data, and utilization data.

The information collected may be reviewed and processed in order to highlight relevant economic risk factors, which may later be used to develop a specific intervention over a designated time period. Thus, the information collected in this first step may be used as a basis for subsequent steps to be completed in order to manage health conditions and risks for the targeted participant. In the context of an example that includes the use of these three information domains (health risk appraisal data, biometric data, and utilization data), the following scenario is illustrative. Participant may complete an interview session in which participant answers truthfully that participant has asthma and a history of heart disease in participant's family (this represents health risk appraisal data). Participant may then be tested using a flow meter connected to a health station that indicates participant has limited lung capacity (this represents biometric data).

Participant may also have blood pressure measured by a cuff connected to health station that indicates participant has high blood pressure (this represents biometric data). Finally, querying participant via live video at a remote health station may yield that participant purchases several inhalers per month, that participant was rushed to the hospital last year for an asthma attack, and that participant is currently taking prescription medication to lower participant's blood pressure (this represents utilization data).

At step 104, relevant risk factors are identified after the data is collected from the three domains. This represents the second step in the process and method for managing participant's health concerns. The purpose of the risk identification step is to discover relevant risk factors that reflect predictable events or conditions and, further, whose modification can lead to a reduction in health risks and disease expression. Modifying or eliminating a risk factor can prevent future health events and disease developments.

At step 106, healthcare individual and/or server can intelligently determine an intervention plan customized to participant based on participant's health risk appraisal data, biometric data, utilization data, risk factors, and any additional relevant health data. Healthcare individual can immediately view and process data associated with participant to provide an intervention plan almost immediately. This provides healthcare individual with specific data to provide an efficient and effective intervention plan to reduce the risk of disease associated with participant.

At step 108, healthcare individual can provide health management in real-time via a video stream to participant at a remote health station. The health management provides the participant with a clear and definitive plan of attack for managing participant's health concerns, such as acute illness, chronic illness, or risk modification. Health station allows one on one interaction between participant and healthcare individual, such that participant will have a more personal experience and be more willing to participate in intervention plans or care suggested by healthcare individual. Healthcare individuals can also interact with participants to obtain any additional data needed.

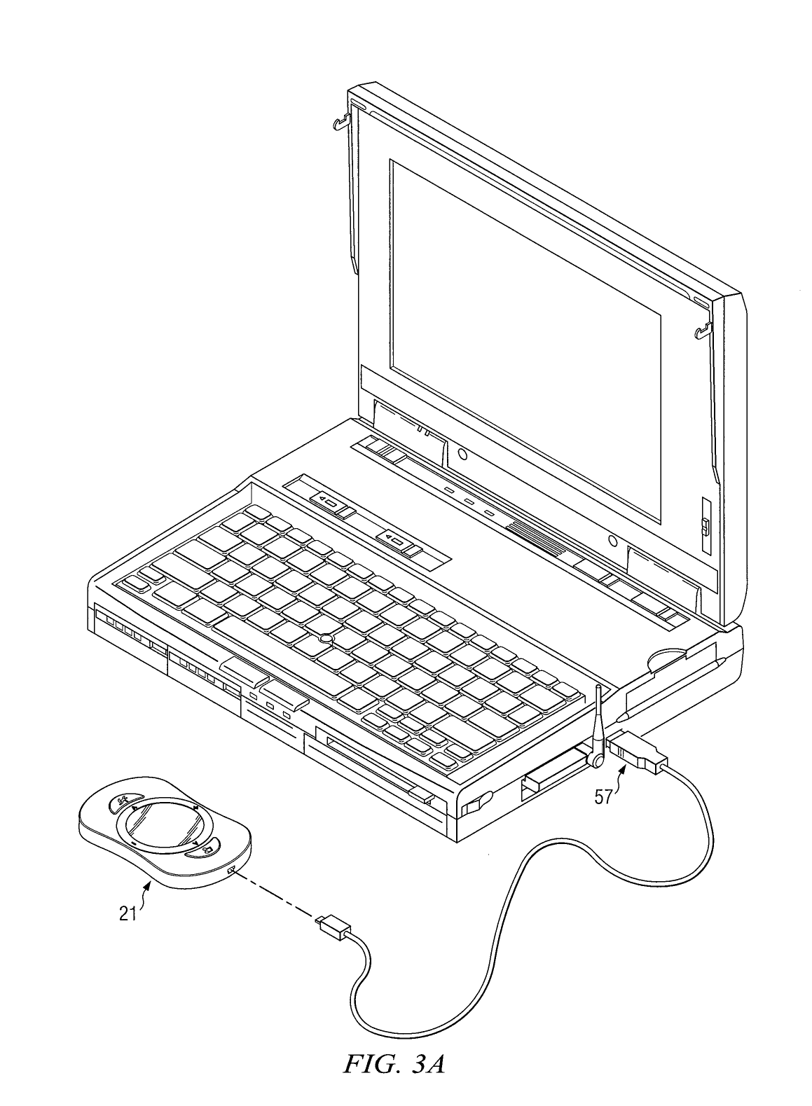

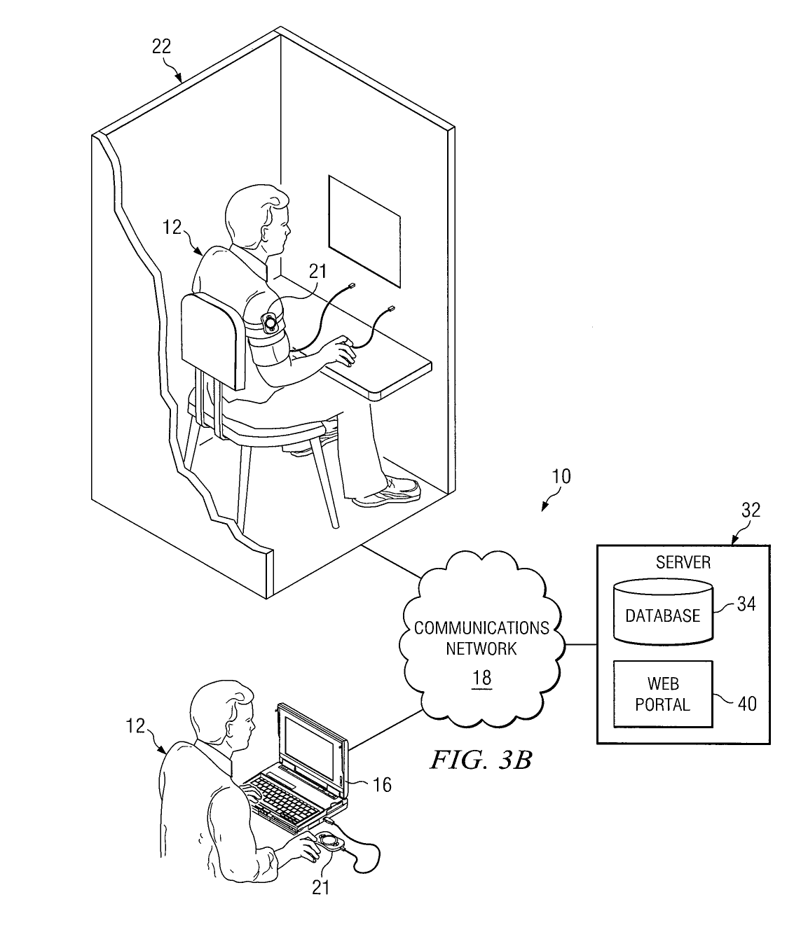

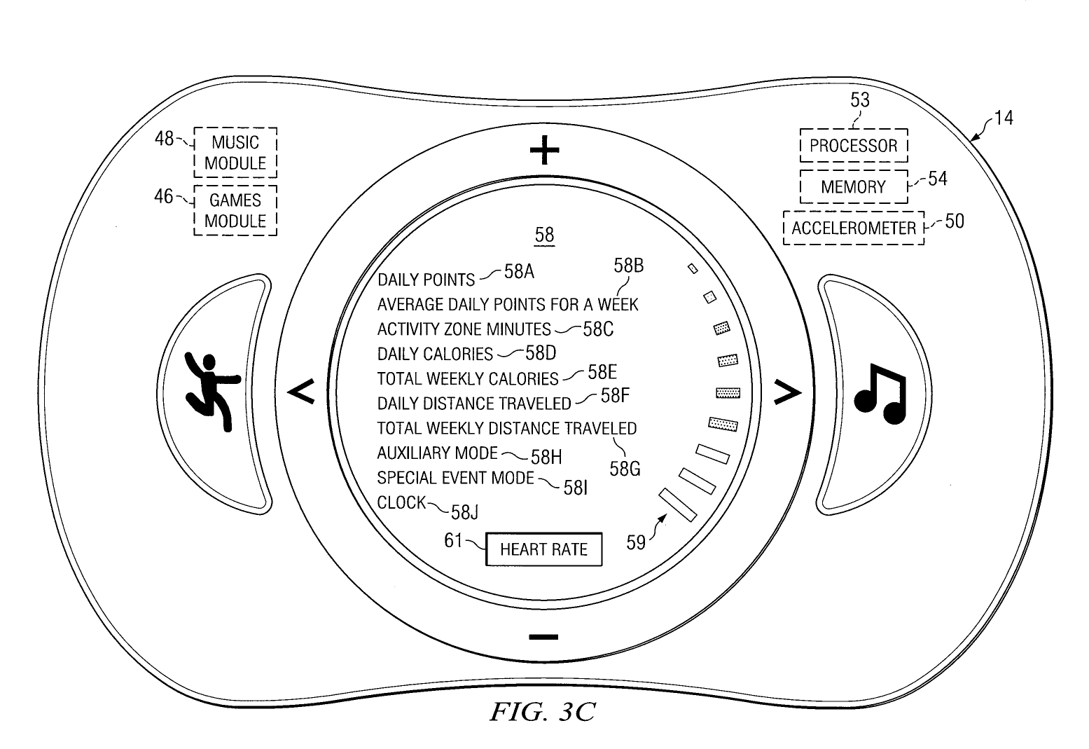

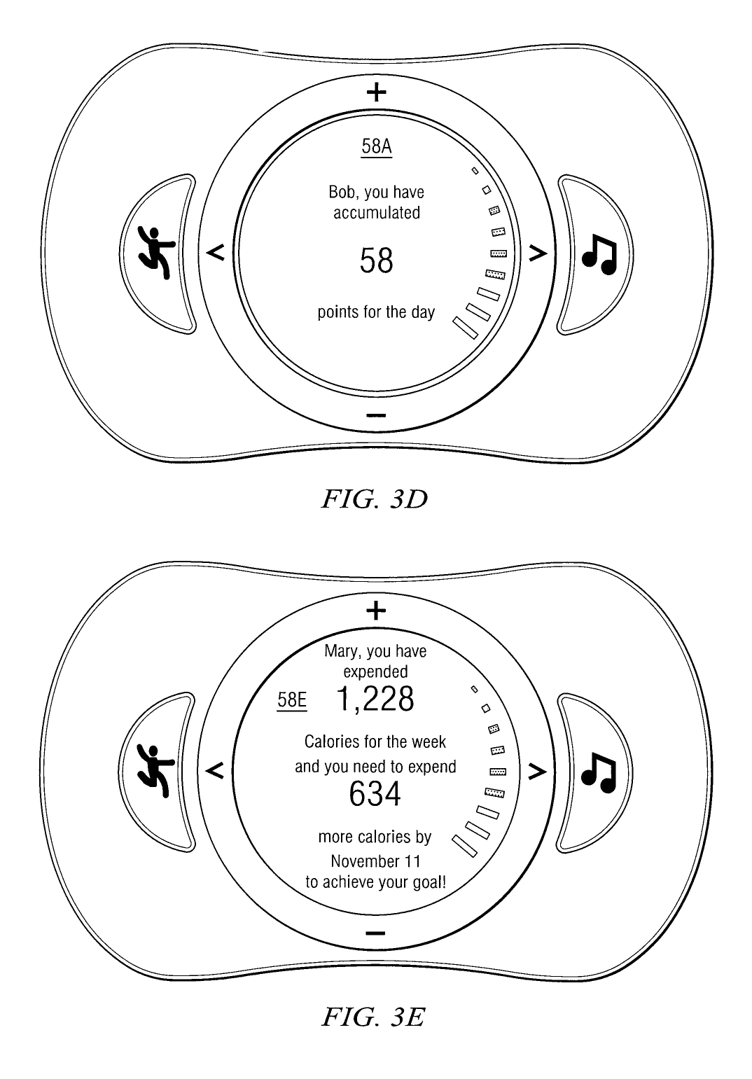

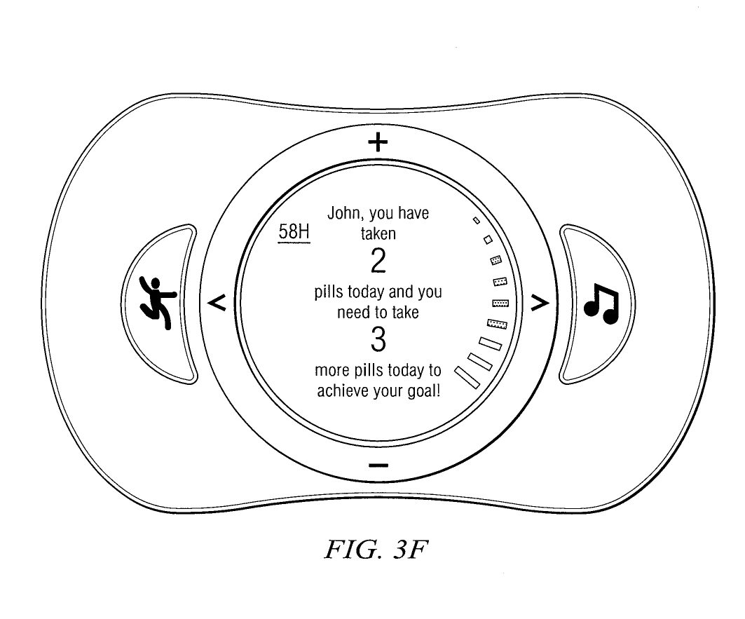

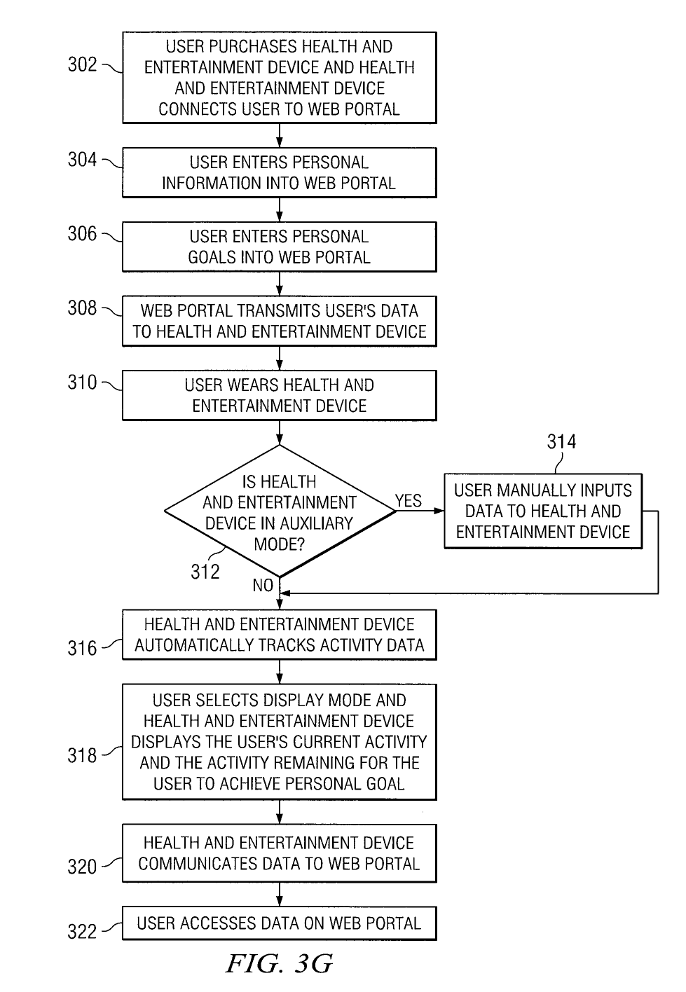

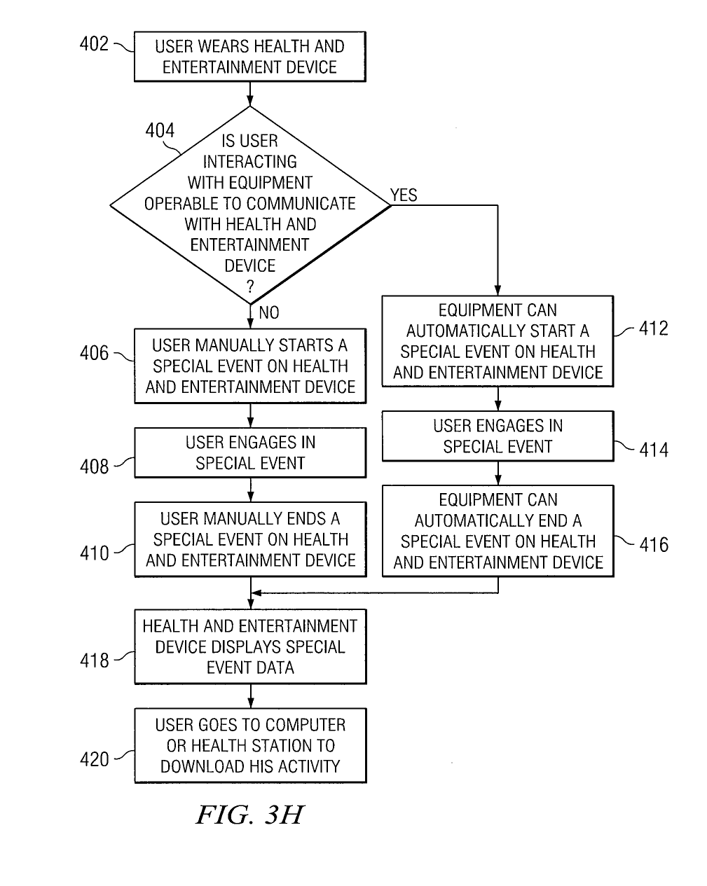

FIG. 3A is a simplified block diagram that illustrates how a participant device 21 can be used with a computer in accordance with system 10. Device 21 can also be referred to as health and entertainment device, which could represent any type of phone, laptop, music player, PDA, video game console, etc. of interest to the end user and which is relatively mobile. This would allow participant 11 to download music after successful completion of an assigned task, or as a reward for adherence to a given program. Note that a wireless configuration is easily accommodated by the present invention, as a port 57 is provided to connect to the device or to wirelessly receive information therefrom. Note that such communications are bidirectional, as a given computer can ping the device as well as the device may systematically deliver data to a given computer system.

Memory 54 may be accessed or otherwise utilized by health and entertainment device 21. Memory 54 may take the form of volatile or non-volatile memory including, without limitation, magnetic media, optical media, random access memory (RAM), read-only memory (ROM), removable media, or any other suitable local or remote memory component. In general, memory 54 may store various data including data from accelerometer, data from processor, and data from web portal.

Port 57 may communicate information and signals to one or more computer devices 16 and receive information and signals from one or more computer devices 16. Port 57 may also communicate information and signals to communications network 18 and receive information and signals from communications network 18. Port 57 represents any connection, real or virtual, including any suitable hardware and/or software that may allow health and entertainment device 21 to exchange information and signals with communications network 18, one or more computer devices 21, and/or other elements of system 10. For example, port 57 enables health and entertainment device 21 to receive data from web portal 40. Port 57 further enables health and entertainment device 21 to transmit data to web portal 40 including all updated activity data.

FIG. 3B is a simplified block diagram of a streamlined version of system 10 for collecting, displaying, converting, and communicating data in a music distribution environment. System 10 includes a communications network 18, one or more end users 12, one or more computer devices 16, one or more health and entertainment devices 21, one or more servers 32, one or more databases 34, and a web portal 40. FIG. 3B could also include various other potential components to be used with health and entertainment devices 21, such as a WiFi network, a cellular network, a Bluetooth connectivity component, a group of satellites, etc. Essentially, anything that can transfer data with or without wires could be included in such a model.

This example is provided to show the options a given end user has in receiving his musical download. The participant can use his personal/work computer or a health station, as is illustrated. The delivery mechanisms could include the participant's actual device, as is depicted.

It should be noted that the present invention is certainly amenable to be used with non-web-based applications. While there are discussions included herein about uploading information to a server of some sort, the architecture of the present invention (and device 21 specifically) can be used in conjunction with servers that are not necessarily web-based. The simplest form of such a server arrangement would be device 21 connecting to a computer that stores the information itself without uploading it to a web-server. Thus, the present invention can be used in conjunction with both web-based and non-web-based applications alike.

In general, users 12 can wear health and entertainment device 21 to track one or more primary metrics. Users 12 can couple health and entertainment device 21 to one or more computer devices 16, which provide users access to a web portal 40. Health and entertainment device 21 can transmit data to web portal 40 or receive data from the web portal 40 (two-way communication).

The device could also communicate via “piggybacking.” The device would be able to send and receive data packets from other devices. This way, users can transmit their information such as device scores, messages, or any other information to each other's device. This would allow one person who went backpacking up in the mountains where there was no possible internet connection to have his data sent to the internet via another person's device that was on the mountain camping trip with him.

Actually, the information could be sent through an unlimited amount of other people's devices before it went to the internet. The device could act as a proxy for sending and receiving other people's data in order to develop a real-time device environment in areas that do not directly have internet signals.

Health and entertainment device 21 can easily be connected to a computer to download songs or to facilitate a connection between the device and a website. In a simple design, device 21 includes an accelerometer, an MP3 player, and either a USB, an RFID (wireless) connection, or a variety of transmission systems. Health and entertainment device 21 also enables wireless games to be played in real-time. Moreover, health and entertainment device 21 also allows for end users to upload their workouts (along with music, routines, etc.) to device 21 so that people can choose their own workouts, or complete the workouts of other people, or get assignments from a healthcare provider, or download healthcare programs and, furthermore, have the workouts show up on the display such that they can be verified, or checked-off as the workout progresses. Simple logging capabilities are easily accommodated by device 21.

Furthermore, these workouts can have custom music or include the same music that was originally designated by the people who designed the workouts. The musical component of device 21 would be able to show what song is being played, or the display could just run off a play list. Some songs could be pre-selected such that when activities reach a given threshold (high or low), as verified by the accelerometer, a specific song is played.

The inherent wireless connection of device 21 will be able to upload information automatically to the Internet, as device 21 is used anywhere. This could allow, for example, an end user to compete in online games throughout the day, or to challenge other users on a piece of fitness equipment such as a treadmill, stationary bike, etc.

Turning to the website component of device 21, system 10 also achieves an effective way for users 12 to view activity data and to receive music segments that are distributed based on completion of a given task. Web portal 40 is operable for users 12 to input customized data, such that the data is unique to each user 12. Web portal 40 is operable to transmit this customized data to health and entertainment device 21. Health and entertainment device 21 is operable to monitor, calculate, and display user's physical activity in a format selected by user 12. Health and entertainment device 21 can display user's current level of performance, or health and entertainment device can continually update and display user's progress for achieving one or more goals.

Communications network 18 couples and facilitates wireless or wire-line communication between computer devices 16, health and entertainment devices 21, and servers 32. Communications network 18 may, for example, communicate Internet Protocol (IP) packets, Frame Relay frames, Asynchronous Transfer Mode (ATM) cells, voice, video, data, and other suitable information between network addresses. Communications network 18 may also communicate data via wireless communications, such as by Wireless Application Protocol (WAP) standard protocols, including 802.11, third-generation (3G) protocols (such as W-CDMA or CDMA 2000, for example), Bluetooth, or Global System for Mobile Communications (GSM) protocols, for example. Communications network 18 may include one or more local area networks (LANs), radio access networks (RANs), metropolitan area networks (MANs), wide area networks (WANs), interactive television networks, all or a portion of the global computer network known as the Internet, and/or any other communication system or systems at one or more locations.

A feature of the present invention includes a subscription model that may include users 12 paying to use web portal 40 and paying to use health and entertainment device 21. For example, server 32 and health and entertainment device 21 are operable for server 32 to disable and/or enable certain functions and modes of health and entertainment device. Server 32 can configure all health and entertainment devices 21 of a group of users 12, such that all health and entertainment devices 21 used by a particular business entity are configured with the same functionality. If user 12 is delinquent in subscription payments, health and entertainment device 21 may be disabled completely and access to web portal 40 may be blocked. Additional details of health and entertainment device 21 are listed below.

Software and/or hardware may reside in health and entertainment device 21 in order to achieve the teachings of collecting data, converting data, displaying data, and communicating data of the present invention. However, due to its flexibility, health and entertainment device 21 may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of health and entertainment device 21 in the context of communication system 10 and, accordingly, it should be construed as such.

Computer devices 16 may comprise computer systems that include appropriate input devices, output devices, mass storage media, processors, memory, or other components for receiving, processing, storing, and/or communicating information with other components of system 10. As used in this document, the term “computer” is intended to encompass a docking station (although USB connections may obviate the need for a docking station entirely), personal computer, workstation, kiosk, network computer, wireless data port, wireless telephone, personal digital assistant (PDA), cellular telephone, game console, one or more processors within these or other devices, or any other suitable processing device. It will be understood that any number of computer devices 16 may be coupled to other computer devices 16 or communications network 18. Computer devices 16 are generally operated by users 12 or coupled with health and entertainment devices 21 to access the interactive community.

A particular computer device 16 may comprise a browser application, such as an Internet web browser, for example. Browser application may allow user 12 of computer device 16 to navigate through, or “browse,” various Internet web sites or web pages. Computer device 16 may also comprise one or more graphics applications, such as a FLASH™ application for example, operable to display various types of data received via communications network 18, such as graphics, video, and streaming data (such as video and/or audio), for example.

A particular health and entertainment device 21 can be coupled to computer device 16 such that user 12 can access the web portal 40 without intervention from a third party (for example, a webmaster forwarding information). Health and entertainment device 21 functions as a digital key to web portal 40 so that users instantly access web portal 40 without having to launch an Internet web browser or type in a username or password. The user will be able to instantly interact with web portal 40.

Servers 32 are generally operable to provide an interface between users 12 and web portal 40. One or more servers 32 may be web application servers or simple processors operable to allow users 12 to participate with web portal 40 via the communications network 18 using a standard user interface language such as, for example, the Hypertext Markup Language (HTML). In some embodiments, one or more servers 32 may be physically distributed such that each server 32, or multiple instances of each server 32, may be located in a different physical location geographically remote from each other. In other embodiments, one or more servers 32 may be combined and/or integral to each other. One or more servers 32 may be implemented using a general-purpose personal computer (PC), a Macintosh, a workstation, a UNIX-based computer, a server computer, a kiosk, or any other suitable processing device. Server 32 may include a processor to convert data and utilize algorithms. For example, server 32 may apply an algorithm to convert distance traveled into calories burned by utilizing data from the memory like a user's height, weight, and sex.

In some embodiments, servers 32 are operable to provide security and/or authentication of users 12 or other persons or entities attempting to access web portal 40. For example, servers 32 may essentially provide a firewall for entities attempting to access web portal 40. In addition, servers 32 may be operable to translate one or more data protocols used by web portal 40 with one or more protocols used by applications hosted by one or more computer devices 16.

In particular embodiments, one or more servers 32 are web application servers operable to communicate dynamically updated information to particular computer devices 16 via communications network 18 including the identity of user 12. For example, one or more servers 32 may communicate updated information on web portal 40 to particular computer devices 16 or health and entertainment devices 21 via communications network 18.

Servers 32 further comprise a memory that may be accessed or otherwise utilized by one or more components of interactive community. The memory may take the form of volatile or non-volatile memory including, without limitation, magnetic media, optical media, random access memory (RAM), read-only memory (ROM), removable media, or any other suitable local or remote memory component. In general, the server memory may store various data including a user's account information, a user's goals, a user's activity data, and a population's activity data.

Databases 34 are operable to store various data associated with web portal 40, such as information regarding users 12, computer devices 16, and health and entertainment devices 21. Databases 34 may communicate with servers 32 such that servers 32 may store information, retrieve information, analyze information, and share information with each other. Databases 34 may provide a backup in the case of outages or other failures of various components of web portal. Other architectures and components of servers 32 may be used without departing from the scope of this disclosure.

Web portal 40 comprises one or more web sites, hardware, and software that provide users of the web with the ability to search for information on the web including information in the web portal 40, documents, media, or other resources coupled to the web. The web sites on web portal 40 may include user's websites and informational websites. Web portal 40 provides a central location for users to get together with each other.

FIG. 3C is a simplified block diagram that illustrates health and entertainment device 21 for collecting, displaying, converting, and communicating data in accordance with a particular embodiment of the present invention. Health and entertainment device 21 includes a games module 46, a music module 48, an accelerometer 50, a processor 53, a memory 54, a display 58, a mode button 60, a special event button 62, one or more input buttons 64, a skin 70, and a clip 80. Display 58 is operable to display an activity meter 59 and several different modes including daily points 58A, average daily points for a week 58B, activity zone minutes 58C, daily calories 58D, total weekly calories 58E, daily distance traveled 58F, total weekly distance traveled 58G, auxiliary mode 58H, special event mode 58I, and a clock 58J. The auxiliary mode can be used as a food management system and a point system can reflect the amount of food taken in. Also included in FIG. 3C is a heart rate component 61, which can provide a plethora of heart rate information to the end user of the device.

Accelerometer 50 is a device that is used to convert an acceleration from gravity or from motion into an electrical signal. The input for accelerometer 50 is generally gravity or motion. Accelerometer 50 can measure acceleration in units of “g's.” One “g” is defined as the earth's gravitational pull on an object or a person. For example, 1 g represents the acceleration exerted by the Earth's gravity on an object or person (for example, a cell phone on a desk experiences 1 g of acceleration). The acceleration range experienced by a person when walking is between 0.1-2.0 g. Accelerometer 50 measures all user activity by instantaneously tracking the full motion and force (for example, acceleration and deceleration) of user's hips and torso.

Processor 53 controls the operation and administration of health and entertainment device 21 by processing information and signals. Processor 53 includes any suitable hardware, software, or both that operate to control and process signals. Processor 53 may be microprocessors, controllers, or any other suitable computing devices, resources, or combination of hardware, software and/or encoded logic. For example, processor 53 may be used to calculate calories by utilizing data from accelerometer 50 and data from web portal 40.

Music module 48 and games module 46 can include preloaded items, items selected from a menu, or these modules can receive information wirelessly or via a USB connection. In one instance, these items can readily receive downloads from a PC such that music and games can be updated periodically. In addition, these items can be used to exchange music between end users or to play games amongst individuals in real-time.

Activity zone minutes 58C can be viewed on display 58. Activity zones may display life zone minutes, health zone minutes, and sport zone minutes. Life zone minutes may include activity consisting of physical activity experienced in the course of daily living such as walking around the house. Health zone minutes may include walking activity or comparable activity consistent with recommendations from the medical community necessary for a beneficial health effect, i.e., such as walking thirty minutes a day most days of the week at some prescribed level of effort. Sport zone minutes may include running activity or activity with similar physical intensity. Web portal 40 or other literature may indicate the amount of time user 12 should strive to accumulate in the activity zones to achieve a healthy lifestyle. Displaying activity zone minutes 58C engages user 12 to stay active until user 12 has accumulated enough activity zone minutes 58C.

Daily calories expended 58D can be viewed on display 58. Health and entertainment device 21 can calculate an accurate amount of calories expended by user 12 by utilizing user's weight, height, sex, and age. Health and entertainment device 21 receives updated information from web portal 40 every time that health and entertainment device 21 connects to web portal 40 such that user 12 never has to manually input data like height, sex, age, and weight into health and entertainment device 21. For example, health and entertainment device 21 can continuously be connected to web portal 40, such that health and entertainment device 21 continuously received information from web portal 40. The total weekly calories expended 58E can also be viewed on display 58. Web portal 40 or other literature may indicate the amount of calories user 12 should expend to achieve a healthy lifestyle. Displaying the amount of calories expended engages user 12 to stay active until user 12 has expended enough calories.

Daily distance traveled 58F can be viewed on display 58. Health and entertainment device 21 may allow user 12 to set the measurement of distance including feet, miles or kilometers, etc. Total weekly distance 58G traveled can also be viewed on display 58. Web portal 40 or other literature may indicate the amount of distance users 12 should travel to achieve a healthy lifestyle. Displaying the amount of distance traveled engages user 12 to stay active until user 12 has traveled far enough.

Auxiliary mode 58H can be viewed on display 58. In auxiliary mode 58H, user 12 can manually input numbers into health and entertainment device 21. For example, a physician may give user 12 a regimen to take three pills a day or eat five vegetables a day [or other suitable items such as cups of water drunk, grams of protein consumed, a number of times a task was done, etc.]. Physician or user 12 may input this information into web portal 40. Web portal 40 can transmit this information to health and entertainment device 21 such that health and entertainment device 21 can display this information. Health and entertainment device is operable for user 12 to manually input each time user 12 takes a pill or eats a vegetable, such that the auxiliary mode displays the updated information. User 12 may press a button on health and entertainment device 21 for every pill or vegetable. User 12 can connect health and entertainment device 21 to web portal 40, such that auxiliary mode 58H information is automatically transmitted to web portal 40. Physician may monitor web portal 40 to make sure user 12 is in compliance of a regimen (for example, user is taking the number of pills per day and eating the number of vegetables per day). Auxiliary mode 58H enables user 12 to properly track a diet regimen or program. For example, the auxiliary mode can be used as a food management system and a point system can reflect the amount of food taken in. Users 12 may not remember how many pills that they have taken throughout the day, and auxiliary mode 58H enables users 12 to track their personal regimen. Physicians can also monitor their patients to make sure that patients are compliant with the regimen prescribed for them.

Special event mode 58I, which can be viewed on display 58, enables user 12 to begin a special event 58I (e.g. walking on an incline of a treadmill) and to end special event 58I. Additionally, special event mode 58I enables machines, like a treadmill, to begin a special event and to end a special event. For example, a treadmill may send a signal to health and entertainment device 21 to begin a special event when the treadmill is turned on and to end a special event when the treadmill is turned off. The health and entertainment device 21 will track the activity data during the special event 58I time period, such that user 12 can monitor activity of specific events. Alternatively, user 12 can manually press a button for special event 58I to begin at the start of a marathon and manually press a button for special event 58I to end when user 12 crosses the finish line. Special event mode 58I enables users to monitor specific activity events, which engages users 12 to become more active.

Clock 58J can be viewed on display 58. Clock 58J can be the time of day. Clock 58J can also be a stopwatch to monitor the amount of time spent on an activity. Activity meter 59 can be viewed on display 58. Activity meter 59 can be one or more bars such that no bars are displayed while user 12 is stationary, and the number of bars displayed will increase as user's current activity level increases.

Mode button 60 on health and entertainment device 21 enables user 12 to toggle through one or more display modes for user 12 to view. For example, user 12 can press mode button 60 to toggle display 58 from daily points to daily calories expended 58D to special event mode 58I, etc. Special event button 62 on health and entertainment device 21 enables user 12 to begin and to end a special event. One or more input buttons 64 on health and entertainment device 21 enable user 12 to input information like incrementing the counter in auxiliary mode 58H.

Skin 70 encases the outside of health and entertainment device 21. Skin 70 can be removable with one or more skins 70. Skin 70 can have different features including a different color, material, and texture. Clip 80 can attach to the back of health and entertainment device 21. Clip 80 enables user 12 to easily attach health and entertainment device 21 to an article of clothing. Clip 80 can be removable with one or more clips 80. Clip 80 can have different features including a different color, material, and texture. Removable, unique skins 70 and clips 80 allows user 12 to customize the appearance of health and entertainment device 21. Users 12 are more likely to wear health and entertainment device 21 by customizing the look of health and entertainment device 21.

Health and entertainment device 21 is operable to transmit activity zone data 58C to web portal 40. Web portal 40 is operable to monitor energy expenditure in normal, active populations, and to monitor activity in relatively sedentary clinical populations, including nursing home residents, outpatients with multiple sclerosis (MS), and obese children.

FIG. 3D is an example display 58 of user's daily points 58A in accordance with an embodiment of the present invention. Health and entertainment device 21 can display customized messages because web portal 40 has transmitted user's personal data to health and entertainment device 21. In this example, user 12 does not have a goal associated with daily points 58A so only the current daily points 58A are displayed.

FIG. 3E is an example display 58 of user's goal for total weekly calories expended 58E. Health and entertainment device 21 can display customized messages because web portal 40 has transmitted user's personal data to health and entertainment device 21. In this example, user 12 has a goal associated with calories expended for the week 58E. As a result, both the current weekly calories expended 58E and the remaining weekly calories to be expended 58E to achieve user's goal are displayed.

Daily points 58A can be viewed on display 58. Daily points 58A are the points user 12 has accumulated in one day. Points can be in a format that is easier for user 12 to understand than other data formats. For example, points may be a two-digit number that is easily understood by user 12 to quickly indicate how active user 12 has been during the course of user's 12 daily life routine. Points may be calculated by multiplying the following ratio by 100, wherein the ratio is the amount of user's energy expended while active and the amount of user's energy expended while at rest. Walking for half an hour may result in seven to fourteen points. Running for half an hour may result in fifteen to thirty points. The exact number of points accumulated will depend on the user's activity. The daily points 58A provide user 12 with a simple and straightforward method to quantify and express the total amount of activity that user 12 achieves over a single day. The average daily points for a week 58B allows user 12 to track how consistent user 12 has been active for the past seven days.

Web portal 40 or other literature may indicate the amount of daily points 58A users 12 should strive to accumulate to achieve a healthy lifestyle. A younger user may need to accumulate a high number of points to lead a very active lifestyle, while an older user may need to accumulate a lower number of points to lead a very active lifestyle. By displaying a simple format like points, health and entertainment device 21 engages user 12 to stay active until user 12 has accumulated enough points because user 12 does not have to track more complicated metrics. The points can readily be exchanged for a music file, song, MP3, music album, or any other music segment.

FIG. 3F is an example display 58 of user's goal for pills consumed in auxiliary mode 58H. Health and entertainment device 21 can display customized messages because web portal 40 has transmitted user's personal data to health and entertainment device 21. In this example, user 12 can have a goal, such as a nutritional regimen or pill regimen displayed in auxiliary mode 58H. As a result, both the current daily pills taken and the remaining daily pills to be taken to achieve user's goal or diet regimen are displayed.

FIG. 3G is a simplified flowchart that illustrates an example method of the communication system 10 in accordance with an embodiment of the present invention. The flowchart begins at step 302, where user 12 purchases health and entertainment device 21 and connects health and entertainment device 21 to web portal 40. At step 304, user 12 inputs personal information into web portal 40 including user's height, weight, age, and sex. At step 306, user 12 also inputs personal goals into web portal 40. For example, user 12 may set one or more personal goals including eating three vegetables a day, expending four hundred calories per day, and spending five hours in the sport zone per week. At step 308, web portal 40 transmits user's data and goals to health and entertainment device 21. Goals can be color-coded on the device.

At step 310, user 12 wears health and entertainment device 21 by attaching clip 80 to an article of user's clothing. If health and entertainment device 21 is in auxiliary mode 58H during step 312, then the user 12 can manually input data into health and entertainment device 21 at step 314. For example, user 12 may press a button to increment the counter for the number of pills user 12 has taken for the day. In step 316, health and entertainment device 21 is constantly tracking user's 12 activities throughout the day while user 12 is wearing health and entertainment device 21. Health and entertainment device 21 is operable to dynamically update user's 12 personal goal information stored in health and entertainment device 21. For example, if user 12 has a daily goal of expending fifty calories and user has expended ten calories for the day, then the health and entertainment device 21 will update the goal such that user 12 only needs to expend thirty more calories to achieve his goal.

At step 318, user 12 can depress mode button 60 to toggle through the activity modes being displayed 58. If the activity mode displayed 58 does not have a goal associated with that activity, then health and entertainment device 21 displays the current activity data to user 12. If the activity mode displayed 58 does have a goal associated with that activity, then the health and entertainment device 21 displays the current activity and the activity remaining to achieve user's goal. At step 320, the collected data may be transmitted to one or more computing devices 16 or web portal 40. This may be achieved in a wireless fashion, via a modem, a universal serial bus (USB) connection, or any other suitable connection, link, or port.

At step 322, the collected data may be accessed by any suitable entity authorized to do so. For example, user 12 himself may review the collected data via his home personal computer. In other scenarios, an employer may seek to review this collected data. In still other scenarios, a provider of healthcare may wish to ascertain this information. The collected data may be presented to these entities in any suitable format, which may be based on user preferences.

FIG. 3H is a simplified flowchart that illustrates an example method of the special event feature of the health and entertainment device 21 in accordance with an embodiment of the present invention. At step 402, user 12 wears health and entertainment device 21 by attaching clip 80 to an article of user's 12 clothing.

If user 12 is not interacting with machines operable to communicate with health and entertainment device 21 during step 404, then user, 12 can manually input for special event 58I to begin at step 406. For example, user 12 can depress special event button 62 before user 12 runs a marathon. At step 408, user 12 engages in special event like running on a marathon. Health and entertainment device 21 measures all activity during the special event 58I. At step 410, user 12 can manually input for the special event 58I to end. For example, user 12 can depress special event button 62 again to end the special event when user 12 crosses the finish line at a marathon. At step 418, the health and entertainment device 21 displays the activity data measured during the special event 58I.

If user 12 is interacting with machines operable to communicate with health and entertainment device 21 during step 404, then special event mode 58I can automatically begin by a signal from the machine at step 412. For example, a treadmill may send a signal to health and entertainment device 21 to begin special event 58I when the treadmill is turned on. At step 414, user 12 engages in special event 58I like running on a treadmill. Health and entertainment device 21 measures all activity during the special event 58I. At step 416, machine can send a signal to health and entertainment device 21 to automatically end special event 58I. For example, a treadmill may send a signal to health and entertainment device 21 to end a special event 58I when the treadmill is turned off. At step 418, the health and entertainment device 21 displays the activity data measured during the special event 58I. Any of the special event data can be transmitted from health and entertainment device 21 to computing device 16, web portal 40, or server 32.

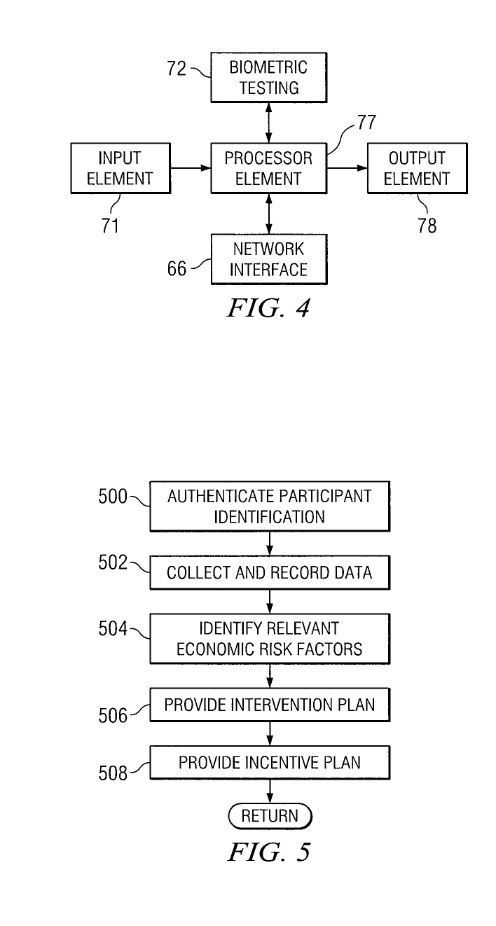

FIG. 4 is a simplified block diagram of a data processing system for delivering and administering certain aspects of the invention. In one embodiment, the data processing system, referred to herein as a health station 22, comprises a processor element 77, an input element 71, an output element 78, biometric testing element 72, and a network interface 66. Health station 22 may represent a computer, server, client, or data processing device, depending on context and applicable tasks. In certain embodiments, input element 71 and output element 78 may be combined into a single user interface element, such as a touch-screen display or kiosk. Moreover, health station 22 generally includes a means for authenticating participant (e.g., a participant in an intervention). The means for identifying a participant may include a card reader, fingerprint scanner, or any other well-known software or hardware authentication system.

Health station 22 provides a means for delivering an intervention to a given population, and thereby modifying risk factors that are driving disease and costs. Moreover, health station 22 may provide a means for administering an incentive program associated with the intervention. Health station 22 may authenticate a participant, track participation, store relevant data, report intervention progress or incentive program status. A data processing system such as health station 22 also may be configured with software, application specific integrated circuits (ASICs), or other means to implement an algorithm associated with intelligently selecting an intervention plan based on participant's health data.

In certain embodiments, network interface 66 may be coupled to a communications network (e.g., the Internet) or any other communicative platform operable to exchange data or information with other data processing systems. The provided communications network may alternatively be any local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment.

When the communications platform is network-based, the functions of health station 22 may be distributed across several health stations 22 or data processing systems. For example, participant history and biometric data 60 may be collected through a first health station 22, and then transmitted to a second health station 22, server 80, or other data processing system at a remote location for storage or further processing. Moreover, several health stations 22 may be located at various locations to service geographically distributed populations, and a network-based health station 22 provides a means for a participant to remotely input, change, or update health data 56, as well as participate in certain intervention activities.

FIG. 5 is a flow diagram that illustrates one embodiment of an algorithm associated with a health station, which implement various steps described above. Such an algorithm may be provided in conjunction with a music distribution as described herein. This algorithm is described from the perspective of a network-based health station, in which the health station is coupled remotely to a server, data processing system, or second health station through a network. In general, a health station requires each participant to be authenticated. While the algorithm contemplates use of a wide variety of authentication algorithms and systems well known in the art, one such means includes an identification card having a magnetic stripe or other computer-readable medium. Alternatively, participant can be authenticated by an activity monitor assigned to participant. Each participant may be issued such an identification card or activity monitor, which uniquely identifies the participant to a health station. Thus, in step 500 the remote health station collects the participant's identification, authenticates the identification, and records the identification. In step 502, the health station collects and records health-related data from the participant. Here, the health station may interactively prompt the participant for the information, such as participant's family health history, or may prompt the participant to activate a biometric testing element to measure certain biometric information. Health station may also connect participant to a healthcare individual via a live video feed, and healthcare individual can interactively query participant for additional information.

In step 504, the health station identifies one or more relevant economic risk factors from the health-related data, using any of the techniques, processes, or systems described above. Healthcare individual can also identify one or more relevant risk factors from health data. In step 506, the health station provides an intervention plan based on the relevant economic risk factors and health data. Again, the health station may be configured to implement any of the techniques, processes, or systems described above to provide the intervention plan dynamically. Alternatively, an administrator may store several static intervention plan options in a centralized server. Health station can intelligently select an intervention plan from server based on the risk factors and health data. Healthcare individual can also provide an intervention plan to participant in a personalized one on one environment via a live video stream. Healthcare individual can provide customized intervention plan based on risk factors and other health data. Step 506 may further comprise steps for delivering elements of the intervention (such as streaming video), tracking participation (e.g., requiring participant authentication before and after viewing a video), storing relevant data, and reporting intervention progress to health station, server, and/or healthcare individual. In step 508, the health station and/or healthcare individual provides an incentive plan to the participant. This step may further comprise tracking and reporting participant's incentive status, and optionally, delivering certain incentives.

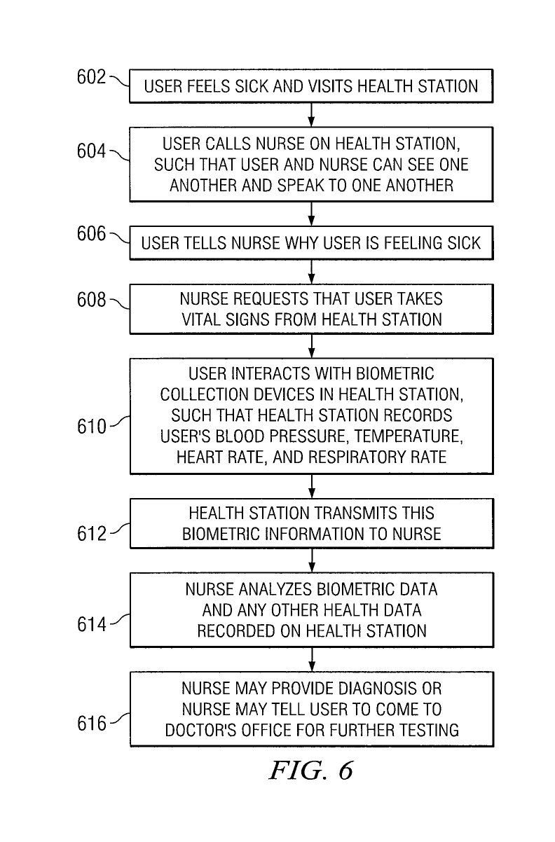

FIG. 6 is a simplified flowchart that illustrates an example method for providing an intervention plan for an acute illness in accordance with an embodiment of the present invention. The plan can be provided in conjunction with a music distribution, as outlined herein. The example process begins at step 602 when employee at company has an acute illness, such as a headache and a runny nose. Employee visits health station, which is located on the company's site. Employee enters participant name and password to log into health station. Allowing employee to visit health station for an acute illness at employee's work site is efficient, immediate, and cost effective for both the employee and the company. At step 604, employee can push a button on health station monitor to call a nurse, such that a live video feed is established. Nurse can see employee in real-time and employee can see nurse in real-time. Additionally, nurse can see any health data that is associated with employee on nurse's computer. At step 606, nurse can ask employee why employee is feeling sick. Employee responds in real time by telling nurse that employee has a headache and a runny nose.

At step 608, nurse can ask employee to measure particular vital signs from health station based on employee's symptoms and employee's health data. At step 610, nurse determines that only the minimal vital signs for diagnosing a common cold should be taken based on employee's symptoms and employee's past health data. Employee can use health station's biometric collection devices to measure employee's temperature, blood pressure, heart rate, and respiratory rate. At step 612, health station transmits employee's biometric data to nurse as biometric data is collected from health station.

At step 614, nurse can analyze employee's current biometric data and employee's past health data stored on centralized server. Employee's biometric data reveals that employee has a high temperature, high blood pressure, a high heart rate, and high respiratory rate. Employee's health data does not reveal any other abnormal health issues. At step 616, nurse can customize the health management for the employee based on employee's health data via the live video transmission. Nurse may determine that employee only has a virus and instruct employee to return home. Nurse can provide additional instructions, such as drink plenty of liquids and get enough sleep. Nurse can tell employee to visit a doctor's office if employee is still feeling sick after 24 hours of complying with nurse's instructions. Alternatively, nurse may determine that employee has a more serious respiratory infection that requires employee to visit a doctor's office for further testing, such as X-rays and/or blood tests. The health station allows for employees to receive immediate, efficient, and cost efficient evaluation, triage and care for acute illnesses.

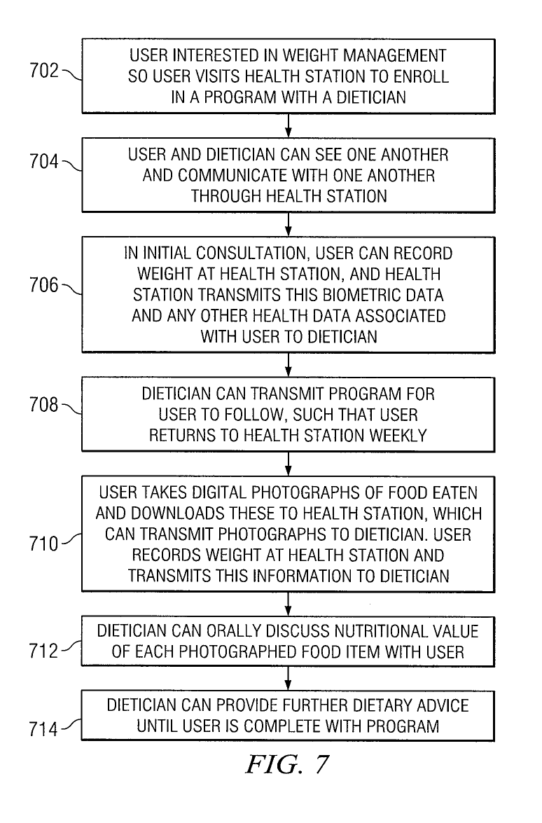

FIG. 7 is a simplified flowchart that illustrates an example method for providing an intervention plan for weight management in accordance with an embodiment of the present invention. The plan could be provided in conjunction with a music distribution feature, as outlined herein. The example process begins at step 702 when participant is diabetic and interested in weight management. Participant can visit a conveniently located health station and log into health station. Participant may own activity monitor that can automatically log participant into health station. An option on health station's display allows for participant to enroll in a weight management plan.

At step 704, participant enrolls in weight management plan and health station can create a video session between participant and dietician, such that they can see and hear one another in essentially real time. At step 706, dietician can view any background health data associated with participant that is stored at a centralized server. Dietician can have an initial consultation with participant to receive more data associated with participant before providing a weight management plan customized to participant. Dietician can request participant to measure particular biometric data from health station, such as weight. Participant can use weight scale connected to health station, such that health station records the weight and transmits this data to dietician.

At step 708, dietician can provide an intervention plan that is customized for participant's health data. Dietician can orally instruct participant of the intervention plan and dietician can transmit an electronic intervention plan to participant, such as a nutrition plan and/or activity plan. For example, dietician can instruct participant to view one or more videotapes that provide nutrition and activity information. Dietician can instruct participant how active to be and how many calories participant should consume per day. Dietician can request that participant electronically record participant's activity data, weight, and/or blood sugar level via a health station or access terminal once per day. In addition, dietician can instruct participant to take digital photographs of all food eaten and to record all activity data with activity monitor. Dietician can request biometric data (weight, blood pressure, blood sugar level), activity data, and nutrition data to be inputted electronically by participant via health station or access terminal. Dietician may request to see participant every two weeks via the live video session through health station. This allows dietician to properly monitor participant, such that dietician can see if participant is complying with intervention plans. Additionally, participants are more likely to participate in intervention plans knowing that a dietician is monitoring them, and that they will be held accountable for their actions in a personalized one on one video communication session.

At step 710, participant engages in intervention plans, such as nutrition plan and/or activity plan. Participant uses digital camera to photograph all food that participant eats, and uploads the photographs to centralized server via port on health station or through website on the internet. Participant wears activity monitor and uploads activity data to centralized server via port on health station or through website on the internet. Participant can measure and transfer biometric data (for example, weight and blood pressure) to centralized server directly from health station or participant can manually enter known biometric data through website on the internet. Dietician can view all updated data inputted from participant, such that dietician can survey participant's progress without a scheduled meeting. Furthermore, dietician can send electronic messages to participant or dynamically change participant's intervention plans.

At step 712, participant returns to health station for follow up consultation with dietician via live video stream. Dietician can review all the digital photographs of food that a participant has eaten. Dietician can explain nutritional value for each food in an interactive and personalized one on one experience with participant. Dietician can display or tell how many calories participant is eating in comparison to how many calories participant is consuming from activity. Also, dietician can query if participant is monitoring blood sugar levels properly since participant is diabetic. At step 714, dietician can continue to provide dietary information and intervention plans to participant until participant completes or withdraws his enrollment in weight management plan.

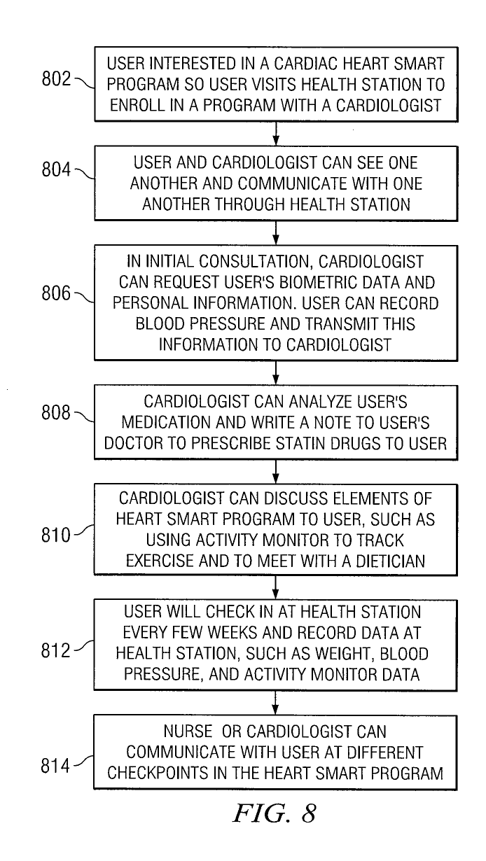

FIG. 8 is a simplified flowchart that illustrates an example method for providing an intervention plan for managing heart disease in accordance with an embodiment of the present invention. The plan could be provided in conjunction with a music distribution feature, as outlined herein. The example process begins at step 802 when participant has experienced one or more heart attacks and participant has his own doctor. Ideally, doctors would like for heart attack victims to participate in proper exercise, dieting, and medications. However, doctors do not effectively follow up with patients who have suffered from heart disease. Physicians excel at acute care, but lack the infrastructure, tracking, monitoring and rewards systems for long-term risk modification. As a result, data reveals that after patients have been prescribed with a statin medicine to lower LDL levels, within 2 years only 50% of patients are still taking their drugs even though it is a known fact that compliance with the medication significantly reduces future cardiac events. Doctors lack the infrastructure to track, monitor, and influence their patients for risk modification. Personal doctor for participant or participant himself can enroll participant in a heart disease intervention plan. Participant can visit a conveniently located health station and log into health station. Participant may own activity monitor that can automatically log participant into health station. An option on health station's display allows for participant to enroll in a “Heart Smart” plan that allows for participant to interact with a cardiologist who can provide an intervention plan to participants with heart disease.

At step 804, participant enrolls in Heart Smart plan, and health station can stream a video introduction of the program to participant. After completing the introduction, health station can establish a live video session between participant and cardiologist, such that they can see and hear one another in essentially real time. Cardiologist can explain to participant that he is not participant's personal doctor, but that he is just here to provide and monitor a Heart Smart plan for participant. Cardiologist can express the importance of complying with the Heart Smart plan to participant, such that participant will be more likely to heed the advice of a qualified healthcare professional in a one on one personalized setting. At step 806, cardiologist can view any background health data associated with participant that is stored at a centralized server, such as details related to heart attacks, past and present medication. prescriptions, by pass surgery, angioplasties, age, weight, gender, etcetera. Cardiologist can have an initial consultation with participant to receive more data associated with participant before providing a Heart Smart plan customized to participant. Cardiologist or nurse can request participant to measure particular biometric data from health station, such as weight and blood pressure. Participant can use weight scale connected to health station, such that health station records the weight and transmits this data to cardiologist. Similarly, participant can use blood pressure arm cuff connected to health station, such that health station records the blood pressure and transmits this data to cardiologist.

At step 808, cardiologist can provide an intervention plan that is customized to participant's health data. Cardiologist can review medication prescribed to participant. For example, cardiologist can notify participant's personal doctor suggesting that statin drugs be prescribed to participant. Additionally, cardiologist can write a note to participant's personal doctor suggesting that different medication for reducing blood pressure should be prescribed since the previous prescription does not seem to be very effective.

At step 810, cardiologist can orally instruct participant of the intervention plan and/or cardiologist can transmit an electronic intervention plan to participant, such as a nutrition plan and/or activity plan. For example, cardiologist may establish a twelve-week plan for participant to complete. Cardiologist can instruct participant to be compliant with medication, meet with a dietician, and use an activity monitor.

Cardiologist can request that participant electronically record participant's activity data, weight, blood lipids, and/or blood pressure level via a health station or access terminal once per day. Cardiologist may request that participant meet with a nurse after six weeks via a live video session through health station. At the completion of the twelve-week plan, cardiologist can meet with participant via a live video session through health station. This allows cardiologist and/or nurse to properly monitor participant, such that they can see if participant is complying with intervention plans. Additionally, participants are more likely to participate in intervention plans knowing that a qualified health professional is monitoring them, and that they will be held accountable for their actions in a personalized one on one video communication session.

At step 812, participant engages in intervention plans, such as medication plan, nutrition plan, and/or activity plan. Participant can electronically confirm that participant has visited doctor for a new prescription, and that participant is complying with taking the medication. Participant can comply with activity plan by wearing activity monitor and uploading activity data to centralized server via port on health station or through website on the internet. Participant can measure and transfer biometric data (for example, weight and blood pressure) to centralized server directly from health station or participant can manually enter known biometric data through website on the internet. Additionally, participant complies with intervention plan provided by dietician. Cardiologist and/or nurse can view all updated data inputted from participant, such that cardiologist and/or nurse can survey participant's progress without a scheduled meeting.

At step 814, cardiologist and/or nurse can send electronic messages to participant or dynamically change participant's intervention plans. Participant returns to health station for follow up consultation with cardiologist and/or nurse via live video stream. Cardiologist and/or nurse can review all submitted data from participant in an interactive and personalized one on one experience with participant. Also, cardiologist and/or nurse can query if participant is monitoring blood lipid levels properly since participant has suffered from a heart attack. Cardiologist can continue to provide health information and intervention plans to participant until participant successfully completes the Heart Smart plan.

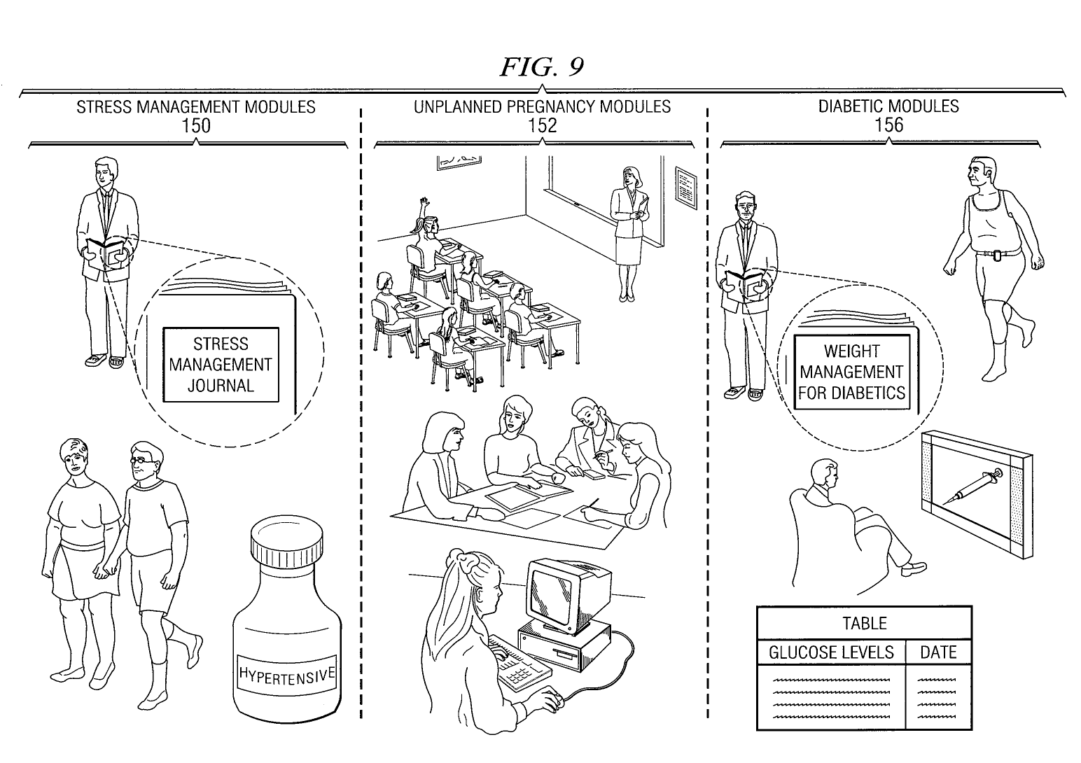

FIG. 9 is a simplified schematic diagram that provides a number of modules that address specific problems identified as relevant economic health risk factors. Successful completion of the module(s) would result in a music distribution reward, as outlined herein. Recall that once a relevant economic risk factor has been identified, a specific intervention may be introduced that is designed to modify the risk factor and create an economic yield. The intervention can be directed toward any risk category: cost clinical risk factors, cost disease state factors, or cost characters. For example, if obesity is discovered to be a prevalent cost clinical risk factor in an employee population, an intervention would be applied (e.g. weight management) to that population to reduce the economic impact of obesity. Similarly, a cost character intervention could address factors such as generic drug purchases or treatment compliance.

FIG. 9 illustrates one series of example modules that include a set of stress management modules 150, a set of unplanned pregnancy modules 152, and a set of diabetic modules 156. The specific modules may include any exercise or task to be completed by the targeted participants. The modules are designed after identifying the relevant economic risk factors associated with the target population. Hence, the identified relevant economic risk factors relate directly to the design of these example modules of FIG. 9. The modules address modifiable economic risk factors associated with the target population that lead to excessive healthcare cost.

In the first set of modules, the issue being addressed is stress management. The ‘STRESS MANAGEMENT JOURNAL’ booklet illustrated in FIG. 9 could include information about proper diet (inclusive of caffeine restrictions), breathing exercises, and time management suggestions. The booklet could include fill-in the blank questions that quiz the individual on the lessons learned. The booklet could also solicit personal reflections from the individual. Completion of question and answer sections could be part of the module booklet, but more substantive feedback could be required from the individual. Such feedback may prove more beneficial as the feedback delves into significant behaviors that affect that individual's actions and, thereby, his healthcare costs.

Stress management modules 150 also include physical exercises to be completed by the participants of the target group. This is illustrated in FIG. 9 by the couple completing a walk. An honor system may be employed for such a module or the participant may wear some type of activity monitor (e.g. a pedometer for tracking walking, a heart rate monitor, etc.). In most cases, the exercise that is proscribed should be completed consistently over a period of time (e.g. a month, three months, etc.). Other modules could include the ingestion of medication in the presence of a nurse or an administrator of the intervention. In the context of stress management and hypertension, an antihypertensive regimen (e.g. Catapres, Wytensin, Apresoline, Hytrin, etc.) is also assigned for this individual through a corresponding module, as illustrated in FIG. 9.

Unplanned pregnancy modules 152 may include various modules, which are similarly designed to affect healthcare costs associated with this group of individuals. In this example, these modules include work completed with a computer and, potentially, monitored by an on-line administrator. The computer module provides an educational tool to be used by the participants in order to better understand pregnancy risks and contraception. Note that such a module could include a significant amount of reflective writing. Simple knowledge of being aware of the present risks for an unplanned pregnancy is not enough. The intent of this module is to help the individual actually process the information that is being presented and, further, to facilitate behavior (based on the knowledge learned) that will translate into a cost savings in healthcare expenditures.

Other modules may be completed in a group setting, as illustrated in FIG. 9. In the context of this example set of unplanned pregnancy modules 152, this includes individuals participating in a group meeting that includes mothers who previously experienced an unplanned pregnancy. Other modules could implement external sources. For example, one module associated with an unplanned pregnancy intervention could include regular attendance at Planned Parenthood meetings for three months, where information is regularly exchanged about contraception, nutrition, exercise, finance, etc. in the context of unplanned pregnancies.

Diabetic modules 156 could include a number of modules that are specifically designed to address health risk factors associated with this unique group. In this example, a booklet entitled ‘WEIGHT MANAGEMENT FOR DIABETICS’ is used to facilitate the changes in personal behavior necessary to achieve weight loss. ‘It's not about food; it's about you.’ Other booklets for diabetics could outline the importance of exercise. For this group of participants (or for a given individual in the group), walking exercises are to be completed. The individual illustrated in FIG. 9 has a pedometer on his waist that tracks the number of steps he takes. This information can then be verified by an administrator or simply downloaded into a computer or a database.

Modules for this individual, in this example, also include a documentary about diabetes to be watched by the individual. The movie could be accompanied by a follow-up exercise that solicits feedback from the individual. This could take the form of a simple interview or an actual test. A module could also simply be the completion or achievement of a specific goal. In the case of a diabetic person with high cholesterol, a reduction of the individual's cholesterol level by fifty points may signify the successful completion of an assigned module. In the case of a diabetic, a table (shown in FIG. 9) is to be used to monitor glucose levels. For example, a diabetic may be reluctant to take his medication. Therefore, a module could be designed specifically to address this problem, whereby a full month of consistent dosages reflects the successful completion of a module. Thus, successful performance of this module may include consistent glucose levels being achieved by the individual and properly recorded in the table.

It is imperative to note that the modules of FIG. 9 only offer one simple example of how an intervention may be introduced to the target group. The specific modules of FIG. 9 may readily be replaced with any other suitable module that targets specific targeted clinical risk factors or character observation or the disease condition of the individual, which was determined to be economically relevant in the preceding step of the process. Moreover, modules could be completed in a specific manner (inclusive of timelines and deadlines) such that the expected result is achieved. Considerable flexibility is provided by these modules as they are tailored to meet the exact needs of the individuals in the target group. It can be appreciated that the module arrangements presented here are arbitrary, as they have been only used for purposes of teaching. Accordingly, any module configurations offered herein in this document should be construed as such: simply one example of the millions of possible combinations and arrangements that may be used.

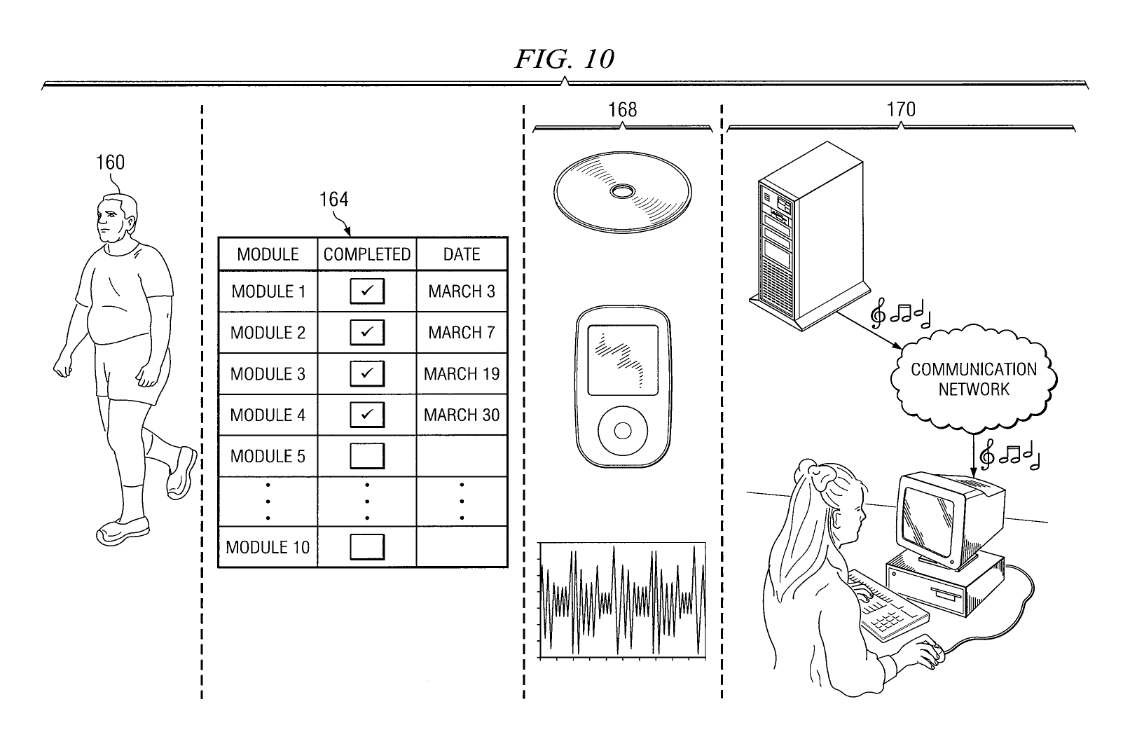

FIG. 10 is a simplified schematic diagram illustrating the interaction between an intervention and an incentive program. Note that higher economic yields are obtained if people have an incentive to engage in a desired behavior. Note that many employees may be reluctant (for whatever reason) to participate in any level of the proposed wellness process. Consider the example where a company is somewhat segmented because of recent mergers or because of the division between union and non-union employees. An effective incentive program may be put in place to address this problem in order to encourage participation. In general, an economic reward is offered to solicit involvement in the program.

Consider one example where the desired behavior to be addressed is stress management. Employees may receive a behavior module that is designed to alter the way in which employees manage their stress. Then they are rewarded with a music distribution for the completion of each module. Each employee can earn merit points (or tickets, coupons, vouchers, etc.) depending on his diligence and efforts.

Merit points allow the employee to earn opportunities to participate in receiving musical downloads. For example, if fifty merit points were earned (e.g. through completion of several modules), this could allow the individual to receive five songs. The more merit points earned (through individual efforts), the more music the end user can receive. The design of the system is to produce a statistically significant number of employees that participate in the modules or a given healthcare/wellness plan.

FIG. 10 offers an example scenario where the issue of sedentary lifestyle is being addressed by a number of modules. An individual 160 (John James) is represented and has been assigned a number of modules 164 to be completed in a given term. Merit points can be earned for completion of the assigned modules. Merit points may then be correlated to music distribution opportunities 168 and potential musical rewards 170 are also illustrated in FIG. 10. In this example, twenty merit points could be earned for twenty thousand steps (through walking exercises) completed by John James. In addition, completion of a workbook could earn fifty points for John James. FIG. 10 illustrates that these two modules were completed on March 3rd and March 7th respectively. Additionally, in this example scenario, John James completed computer modules #3 and #4 on March 19th and March 30th respectively. March 30th represents the end of the term for Company Alpha.

Thus, a music distribution could be provided on April 1st (or soon thereafter) for all those individuals who earned merit points during this one-month time interval. Music distribution opportunities 168 could include: songs, music files, MP3s, MP4s, .wav files, albums, etc. As used herein, all of these items can be included in the broad term “music segment” for purposes of claim interpretation.

It is important to note that the stages and steps described above in the preceding FIGURES illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within health station to effectuate the tasks and operations of the elements and activities associated with executing compatibility functions.

Certain features of the invention have been described in detail with reference to particular embodiments in FIGS. 1-10, but it should be understood that various other changes, substitutions, and alterations may be made hereto without departing from the sphere and scope of the present invention. For example, although the preceding FIGURES have referenced a number of relevant health risk factors, any suitable characteristics or relevant parameters may be readily substituted for such elements and, similarly, benefit from the teachings of the present invention. These may be identified on a case-by-case basis, whereby a certain participant may present a health risk factor while another (with the same condition) may not. Thus, a statistical relevance may be identified for one group, but not another who appears to be similar. Additionally, different and unique intervention plans can be customized by healthcare individuals and/or servers.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method, comprising:
interacting with a participant at a remote location; and
delivering a music segment in exchange for a successful completion by the participant of a health related activity, wherein the music segment serves as a reward for the participant to complete the activity.

2. The method of claim 1, wherein the delivery of the music segment is done via e-mail, a USB port exchange, or through a website.

3. The method of claim 1, wherein the interacting is performed through a website, a health station, or a kiosk.

4. The method of claim 1, wherein the music segment is delivered to a device to be worn by the end user.

5. The method of claim 4, wherein the device is a music player, an accelerator, a phone, a PDA, or a laptop.

6. The method of claim 1, wherein the music segment is earned through a point system that relates to the activity performed by the participant.

7. The method of claim 1, wherein the music segment is a music file, a song, an MP3, a portion of a music album, a complete music album, a .wav file, or an MP4.

8. The method of claim 1, further comprising:
identifying one or more relevant risk factors from health-related data collected from the participant; and
analyzing the risk factors to determine an intervention plan for the participant.

9. The method of claim 10, wherein the intervention plan is determined by a healthcare individual, wherein the healthcare individual is a selected one of group of healthcare individuals, the group consisting of:
a) a physician;
b) a cardiologist;
c) a nurse;
d) a dietician;
e) a non-licensed individual; and
f) a licensed individual.

10. The method of claim 1, further comprising:
providing a health station as the remote location;
capturing biometric data from the participant at the health station;
storing the biometric data;
transmitting the biometric data; and
analyzing the biometric data to determine an intervention plan for the participant.

11. A method, comprising:
interacting with a participant at a remote location; and
delivering a video segment in exchange for a successful completion by the participant of a health related activity, wherein the video segment serves as a reward for the participant to complete the activity.

12. The method of claim 11, wherein the delivery of the video segment is done via e-mail, a USB port exchange, or through a website.

13. The method of claim 11, wherein the interacting is performed through a website, a health station, or a kiosk.

14. The method of claim 11, wherein the video segment is delivered to a desktop computer, a laptop computer, or a personal digital assistant (PDA) device.

15. The method of claim 14, wherein the video segment comprises access to digital content.

16. The method of claim 11, wherein the video segment is earned through a point system that relates to the activity performed by the participant.

17. The method of claim 11, wherein the video segment is a movie download, an episode of a TV series, an entire season of the TV series, a software package, or a video game.

18. The method of claim 11, further comprising:
identifying one or more relevant risk factors from health-related data collected from the participant; and
analyzing the risk factors to determine an intervention plan for the participant.

19. The method of claim 11, wherein the intervention plan is determined by a healthcare individual, wherein the healthcare individual is a selected one of group of healthcare individuals, the group consisting of:
a) a physician;
b) a cardiologist;
c) a nurse;
d) a dietician;
e) a non-licensed individual; and
f) a licensed individual.

20. The method of claim 11, further comprising:
providing a health station as the remote location;
capturing biometric data from the participant at the health station;
storing the biometric data;
transmitting the biometric data; and
analyzing the biometric data to determine an intervention plan for the participant.
